(19) United States
(12) Patent Application Publication
(10) Pub. No.: US 2013/0173358 A1
(43) Pub. Date: Jul. 4, 2013

(54) ASSOCIATING VEHICLES WITH ADVERTISEMENT DISPLAY AND CONVERSION

(71) Applicant: Michael Collins Pinkus, Alpharetta, GA (US)

(72) Inventor: Michael Collins Pinkus, Alpharetta, GA (US)

(73) Assignee: FRIAS TRANSPORTATION INFRASTRUCTURE LLC, Las Vegas, NV (US)

(21) Appl. No.: 13/342,846

(22) Filed: Jan. 3, 2012

(51) Int. Cl. G06Q 30/02

(52) U.S. Cl. 705/14.1; 705/14.63; 705/14.62; 705/14.41

(57) ABSTRACT

A deal manager associates a unique vehicle-offer code or identifier to each vehicle and/or advertisement to be displayed on a vehicle. The unique vehicle-offer code or identifier corresponds to an advertisement on one vehicle such that the vehicle can be uniquely identified. A brief description of the promotional offer and/or the vehicle-offer code may be displayed on the associated vehicle. A consumer may request additional information about the promotion offer through the use of the vehicle-offer code or other identifier. When the consumer receives the additional information, the consumer may have an opportunity to purchase the promotional offer, thereby creating a “conversion.” The identity of the vehicle displaying the brief description of the promotional offer and/or its location may then be determined through the use of the unique vehicle-offer code. The location of the consumer at the time of interest and at the time of conversion may also be determined.

### CROSS-REFERENCE TO RELATED APPLICATIONS

This application is related to applicants' co-pending application, DISCOUNT OFFER SYSTEM AND METHOD FOR USE WITH FOR HIRE VEHICLES, application Ser. No. 13/249,027, filed Sep. 9, 2011, which is hereby incorporated by reference in its entirety.

### BACKGROUND

The present disclosure relates to the field of for-hire vehicles such as taxis, limousines, shuttles, buses or any other vehicle that provides shared transportation or transports one or more passengers between locations of the passengers' choice. The present disclosure also relates to the field of advertising.

A for-hire vehicle (FHV) generally charges fares for transporting a passenger from one location to another. Some FHVs, such as taxicabs, operate with a meter, while others such as limos and shuttles transport passengers for a pre-trip negotiated rate. FHVs are common in tourist destinations, business traveler destinations (for example, where convention centers are prevalent) or in densely populated urban areas where vehicle ownership is uncommon or impractical. Areas of high FHV use often offer numerous entertainment options. The entertainment options may include, among other things, shows, plays, concerts, dining, sporting events, or other special events. Travelers, business people and urban dwellers may frequent these entertainment options through the use of a FHV. For example, a business person in town for a convention may wish to dine at a restaurant and may hail or reserve a taxi to transport him to the restaurant.

Many entertainment options are time, location and quantity sensitive; the entertainment options offer a service that is available for a fixed time, at a specific location and only for a fixed number of people. For example, a play may start at 8 PM (fixed time), be performed at the Downtown Theater (specific location) and have 200 seats available (fixed number of people). In some cases, the number of tickets sold for the event is less than the seats available. For example, only 150 tickets may have been sold for the play in the 200 seat venue. As the 8 PM start time approaches, it may become clear to the vendor operating the play at the venue that the remaining 50 seats will not be sold. Once the play starts, any empty seat in the venue is a lost revenue opportunity. Even though the restaurant, as an entertainment option, may not be strictly time sensitive restaurant owners face a similar lost revenue opportunity when there is adequate staff to serve all of the tables in the restaurant but there are not enough patrons to fill the tables.

### SUMMARY

In one embodiment, a method of advertising using vehicle displayed advertisements is disclosed. The method may include associating a unique identifier with a vehicle displaying an advertisement, receiving a request for additional information containing the unique identifier, determining the additional information to be provided based at least in part on the unique identifier and determining the location of the vehicle associated with unique identifier at the time the request for the additional information was made. A system executing the method is also disclosed. Other embodiments may comprise one or more of the following: determining the location of the vehicle based at least in part on location data received from the vehicle, and determining the location of the vehicle based at least in part on the location of the request for the additional information. In some embodiments, the unique identifier may be an alphanumeric code or it may be an image. The unique identifier may also be a medallion or license plate associated with a for-hire vehicle.

In another embodiment, a method of offering discount vouchers is disclosed. The method may include generating an advertisement associated with a unique identifier, the unique identifier further associated with a vehicle; communicating, to a vehicle computer system associated with the vehicle an instruction to display the advertisement; receiving a consumer communication from a consumer application configured to execute on a consumer computing system, the consumer communication comprising the unique identifier associated with the vehicle; generating an offer for goods or services based at least in part on the unique identifier of the consumer communication; and communicating the offer for goods or services to the consumer computing system. A system executing the method is also disclosed. Other embodiments may include: receiving an acceptance of the offer for goods or services from the consumer computer system; processing the consumer payment information; receiving personal data about the consumer; sending one or more additional advertising offers to the consumer application configured to execute on the consumer computing system based at least in part on the personal data about the consumer. In some embodiments, the consumer application comprises a user interface for entering the unique code, and in some embodiments, the unique code may be obtained from a scanned image.

In another embodiment, a method of distributing offers using vehicle displays is disclosed. The method may include generating through a computer system, an offer configured for display by the vehicle; receiving, by the computer system, one or more location-code messages from the vehicle, the one or more location-code messages comprising: location information describing the location of the vehicle when the vehicle sent the location-code message, and a currently displayed code that is among the one or more codes associated with the vehicle; receiving, by the computer system, a consumer communication comprising a consumer selected code that is among the one or more codes associated with the vehicle; comparing, by the computer system, the consumer selected code of the consumer communication to the currently displayed code that is part of the one or more location-code messages to determine a matched location-code message; and, determining the location of the vehicle using the location information of the matched location-code message. A system performing the method is also disclosed. Other embodiments may include communicating the one or more codes associated with the vehicle to a display computer system associated with the vehicle. In some embodiments, the display computer system associated with the vehicle is configured to display one of the one or more codes associated with the vehicle for a period of time.

In another embodiment, a system for advertising is disclosed. The system may: receive a plurality of network identity values, the plurality of network identity values identifying one or more wireless networks associated with one or more vehicles; identify one or more available wireless networks broadcasting from one or more vehicles; determine a selected network by comparing the one or more available wireless networks to the received network identity values; establish a connection to a server through the selected network whereby the server is provided with sufficient information to identify the vehicle and to select an advertisement based in part on that identification; and, receive an advertisement from the server. In other embodiments, the system may also: receive one or more advertising codes via the selected network; display the received one or more advertising codes in a user interface for selection; receive an offer for goods or services in response to communicating the advertising code and the network identity value; receive an acceptance of the offer from the user; communicate the acceptance to the server; and, communicate payment information of the user to the server.

In another embodiment, a method of providing feedback regarding vehicle advertising impressions is disclosed. The method may include periodically receiving one or more vehicle communications, the vehicle communications comprising a vehicle location; receiving a consumer communication, the consumer communication comprising a consumer location, and consumer input data, wherein the consumer input data represents unique information displayed by a vehicle; and determining, by the computer system, a vehicle location by comparing the consumer communication to the one or more for-hire vehicle communications. A system performing the method is also disclosed.

In another embodiment, a method for advertising is disclosed. The method may include providing an offer configured for display on a for-hire vehicle computer system; communicating the offer to the for-hire vehicle computer system; receiving passenger acceptance data comprising an indication that a passenger of a for-hire vehicle has accepted an offer; receiving passenger contact information data; communicating a unique offer code to the passenger using the received passenger contact information data; and receiving offer conversion data from a passenger computer system, the offer conversion data comprising: the unique offer code, and passenger payment data wherein the passenger inputted the unique offer code into an application executing on the passenger computer system configured to communicate with the advertising computer system, and the passenger payment data was generated by the mobile application based at least in part on data entered by the passenger and stored on the passenger computer system.

In another embodiment, a method of providing a promotional offer to a consumer is disclosed. The method may include receiving a first promotional offer relating to a first venue at a first location; receiving a second promotional offer relating to a second venue at a second location; receiving a deal identifier representing the identity of a vehicle; selecting either the first promotional offer or the second promotional offer based at least in part on the deal identifier; and, generating a computer displayable offer based on the selection of the first promotional offer or the second promotional offer. In other embodiments, the method may further comprise: receiving the deal identifier from a computer system and communicating the computer displayable offer to the computer system; receiving location data from the computer system; selecting the first promotional offer or the second promotional offer based at least in part on the received location data; receiving personal data about a consumer; selecting the first promotional offer or the second promotional offer based at least in part on the received personal data about the consumer; receiving location data describing the location of the vehicle identified by the deal identifier; and, selecting the first promotional offer or the second promotional offer based at least in part on the received location data describing the location of the vehicle identified by the deal identifier.

### BRIEF DESCRIPTION OF THE DRAWINGS

FIG. 1A illustrates one embodiment of a deal manager computer system in communication with a deal conversion computer system.

FIG. 1B illustrates one embodiment of a deal manager computer system in communication with a deal presentation computer system and a deal conversion computer system.

FIG. 1C is a block diagram illustrating the temporal flow of data for one embodiment of a deal manager computer system that is in communication with a deal presentation computer system and/or a FHV, and a deal converter computer system 140.

FIG. 2A illustrates one embodiment of a deal manager computer system in communication with a deal presenter computer system and a deal converter computer system.

FIG. 2B is a block diagram illustrating the temporal flow of data for one embodiment of a deal manager computer system that is in communication with a deal presentation computer system and/or FHV, and a deal converter computer system.

FIG. 3A illustrates one embodiment of a deal manager computer system in communication with a deal converter computer system. The deal converter computer system may also be in communication with one or more FHVs

FIG. 3B is a block diagram illustrating the temporal flow of data for one embodiment of a deal manager computer system that is in communication with a deal presentation computer system and/or FHV, and a deal converter computer system.

FIG. 4A illustrates another embodiment of a deal manager computer system in communication with a deal presentation computer system and a deal converter computer system.

FIG. 4B illustrates another embodiment of a deal manager computer system in communication with a deal converter computer system.

FIG. 4C is a block diagram illustrating the temporal flow of data for one embodiment of a deal manager computer system that is in communication with a deal presentation computer system and/or a FHV, and a deal converter computer system.

FIG. 5A illustrates another embodiment of a deal manager computer system in communication with a deal presentation computer system and a deal converter computer system.

FIG. 5B is a block diagram illustrating the temporal flow of data for one embodiment of a deal manager computer system that is in communication with a deal presentation computer system and/or FHV, and a deal converter computer system.

FIG. 6 is a flowchart illustrating a process flow for advertising using vehicle displayed advertisement in one embodiment of a deal manager computer system.

FIG. 7 is a flowchart illustrating a process flow for distributing offers using vehicle displays in one embodiment of a deal manager computer system.

FIG. 8 is a flowchart illustrating a process flow for displaying an advertisement in one embodiment of a deal presenter computer system.

FIG. 9 is a flowchart illustrating the process flow for communicating an offer to a passenger of a for-hire vehicle in one embodiment of a deal manager computer system.

FIG. 10 is a flowchart illustrating a process flow for providing a promotional offer to a consumer in one embodiment of a deal manager computer system.

### DESCRIPTION OF EMBODIMENTS

Embodiments of the disclosure will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

In order for vendors offering entertainment options to maximize their revenue opportunity when dealing with a time, location and quantity sensitive asset, an opportunity arises to advertise, for a short period of time, the entertainment option at a discount. The present disclosure recognizes this opportunity and that it is advantageous for vendors to offer discounted rates for their entertainment options to consumers through the use of for-hire vehicles (FHVs), or other vehicles that may travel in areas of heavy foot traffic. As FHVs generally operate in areas of high consumer density, vendors have the ability to present advertisements to a large number of consumers through the use of FHV advertising.

While FHV advertising may present excellent opportunities to reach a potential consumer, the entity offering the FHV advertising, and the vendors using the FHV advertising, may have difficulty linking a particular ad view, or impression, with a consumer's interest in the advertisement. In addition, when the consumer acts on the advertisement, that is, when a deal or offer made through the advertisement is converted to a sale (a “conversion”) it may be difficult or impossible to automatically determine the ad view or impression that lead to the conversion since the advertisement may be displayed on one or more FHVs at a time. Linking of ad views to conversions may offer several benefits. For example, it may provide an opportunity to understand which vehicle advertisements are the most effective. In addition, knowing the location of the advertisement at the time a consumer became interested in the advertisement or at the time of conversion may provide data that can help determine the best location(s) to display advertisements. Since a mobile advertisement constantly changes locations, a problem exists in determining the location of where a consumer became interested in an advertisement, and the location of where the consumer bought the product or service being advertised.

The embodiments disclosed herein describe systems and methods that seek to associate a mobile advertisement displayed on a vehicle with a consumer interested in the advertisement or a conversion. In some embodiments, a unique code is associated with a vehicle. The vehicle may provide a static display containing the unique code. The vehicle may also display a brief description of a service or product that may be purchased at a discount using the unique code. When a consumer is interested in the product or service displayed by the vehicle, he may request additional information using the unique code. In some embodiments, the request is made through an application executing on a computing device of the consumer. Once a consumer enters the code into the application, the consumer may be presented with additional details about a service or product offered at a discount, or in some embodiments, additional details pertaining to the brief description of the service or product displayed by the vehicle. In some embodiments, the consumer is presented with an offer to purchase the service or product through the mobile device. Since each code is unique to a vehicle, the specific vehicle that displayed the code that lead to a consumer entering a code or leading to a conversion may be advantageously determined.

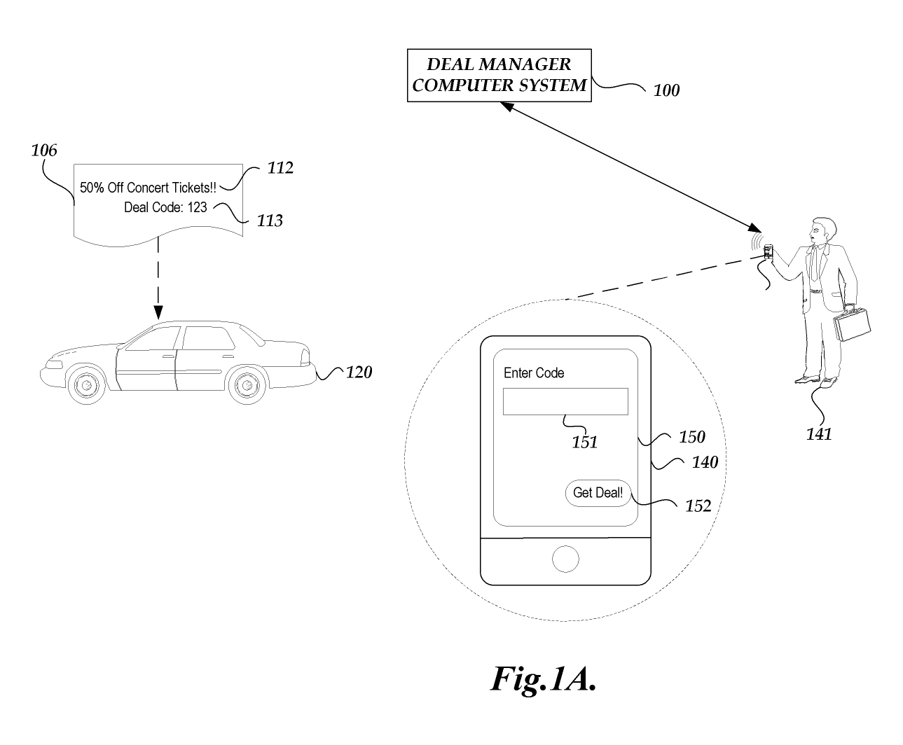

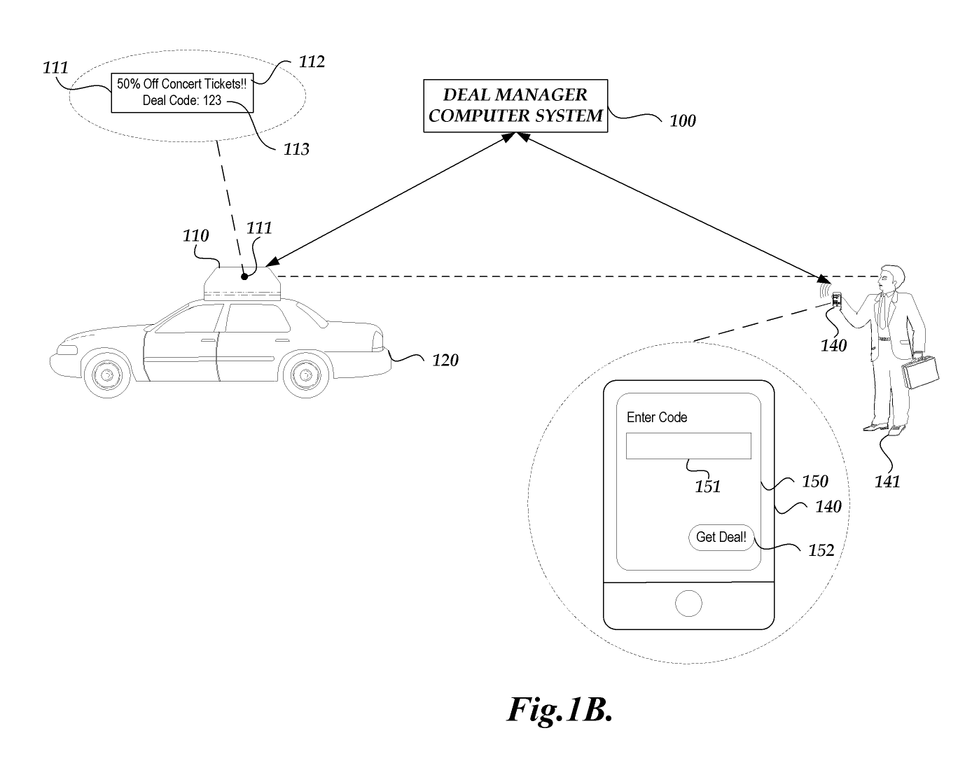

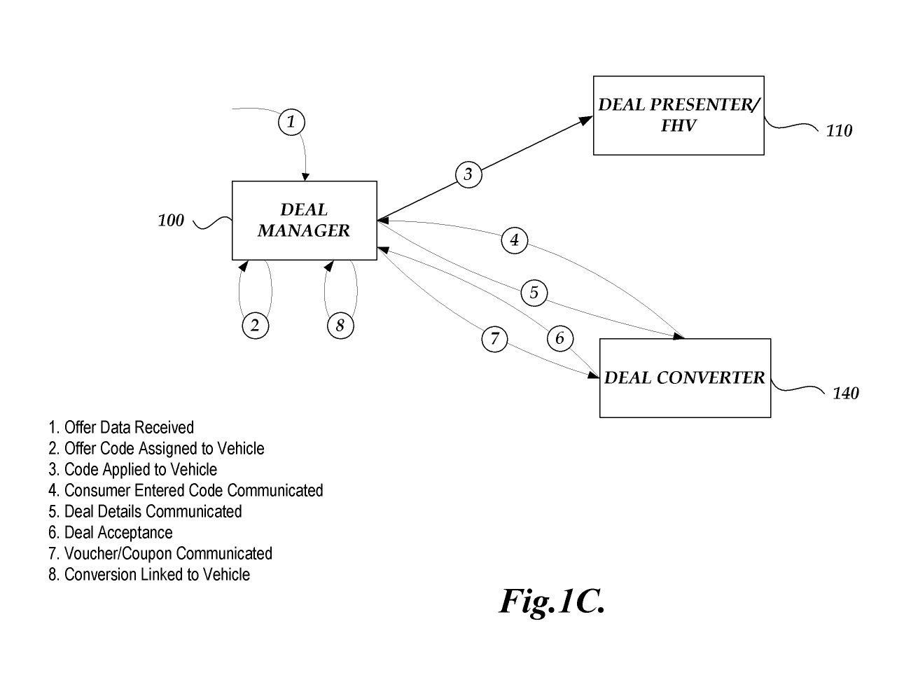

FIG. 1A illustrates one embodiment of a deal manager computer system (“deal manager”) 100 in communication with a deal conversion computer system (“deal converter”) 140. In one embodiment, the deal manager computer system creates static ads that may be shown by the FHV 120. These static ads may, for example, be printed signs that are attached to the exterior or interior of the FHV 120. A unique FHV-offer code or identifier may advantageously be associated with the FHV on which the static ad is placed. The FHV offer code or identifier may be printed on the ad or may be available to the consumer in other ways including by displaying the code or identifier on the FHV separate from the ad or by associating the location of the consumer with the location of the FHV to uniquely identify the FHV when the consumer accesses the deal application and/or website or by recognition of an image taken by the consumer of the vehicle that is used to uniquely identify the vehicle (this could be for example a QR code, a license plate or a medallion). The deal converter 140 may, in some embodiments, execute an application that allows a consumer to get information about a deal and purchase the deal using the unique FHV-offer code. The deal converter 140 may be, in some embodiments, a mobile computing system such as a phone, tablet, laptop, or other portable computing device. For example, in the illustrative embodiment of FIG. 1A, the deal converter 140 is a mobile phone. When a consumer wishes to receive more information about a deal displayed by the FHV 120, the consumer may enter the displayed code 113 into an application 150 executing on the deal converter 140. In some embodiments, the entry of the code may result in a connection to a website showing the offer for a particular consumer.

In one embodiment, the deal manager 100 creates advertisements or deals based on instructions from vendors. The deal manager 100 may receive a promotional offer or deal information from one or more vendors that wish to leverage the mobile characteristics of FHVs to advertise for services. In some embodiments, the deals may be for a time, location, or quantity sensitive asset. For example, a deal may be a discount coupon for attending a show. A vendor offering the show may wish to fill empty seats of its venue shortly before the show begins. The vendor may decide to offer discount coupons, for example, offering seats for 50% off the usual ticket price, and the offer may expire once the show starts or shortly before the show starts. For example, a vendor may offer a show costing $100 a seat that starts at 8 PM. At 7:30 PM, the vendor may determine that the venue of the show is only half filled. The vendor may then wish to offer, for the next 30 minutes, tickets to the show for only $50 so that the vendor may maximize its revenue for the show. The vendor may then submit promotional offer or deal information to the deal manager 100 so that the vendor's offer is displayed through the use of FHVs throughout a region. Embodiments of vendors submitting promotional offer or deal information to a deal manager computer system are described in applicants' co-pending application, DISCOUNT OFFER SYSTEM AND METHOD FOR USE WITH FOR HIRE VEHICLES, application Ser. No. 13/249,027, filed Sep. 9, 2011, which is hereby incorporated by reference in its entirety.

In other embodiments, the vendor's offer may not be time sensitive, but rather, may be a promotional offer that lasts for longer duration. For example, a restaurant vendor may wish to advertise discount coupons for a buffet for the month of December, or hotel may wish to advertise discount rate vouchers that may be purchased anytime, but are redeemable for certain predefined time periods where occupancy may be low. In such embodiments, the vendor may submit deal information to the deal manager 100 so that the deal manager 100 may create deals to be displayed on or in FHVs.

In some embodiments, once the deal manager 100 receives promotional offer data, it may provide the promotional offer data to a consumer in response to the consumer sending a unique FHV-offer code to the deal manager 100 through a deal converter 140 or through a website hosted by the deal manager 100. In such embodiments, the FHV 120 may provide little, or no, information about the deal that is currently offered thereby advantageously leaving the deal manager 100 to provide a deal based on the available promotion offer data it has received. Thus, at two different times, the same unique FHV-offer code may yield two different deals. For example, the FHV 120 may display deal code “123”, and may have no, or very little, information about what deal the code will provide. In some embodiments, the FHV may advantageously provide some hints about the benefits of using the deal code to get more details about the deal. For example, the static ad on the FHV may say “For great deals, scan this code with your mobile phone to download our app!” The code may be, for example, a QR Code. The code would then function to access the deal manager 100 (or a website hosted by the deal manager 100) and if the application has not already been downloaded and installed on the device scanning the code, the application would be automatically downloaded and installed on the device.

For example, the deal manager 100 may receive first promotional offer data for a discount hotel room from a hotel vendor that is good for any time. The deal manager 100 may also receive second promotion offer data providing a deal for a show (a time sensitive asset) from a theater vendor. The theater vendor's offer is only valid from 5 PM to 5:30 PM. When the deal manager 100 receives the unique FHV-offer code “123” at 4:55 PM, it may provide the details of the first promotion offer data (the hotel deal). The deal manager 100 may receive a second request for a deal with the same unique FHV-offer code “123” at 5:05 PM, but may provide details of the second promotional offer data (the show deal) instead of the first promotional offer data. The deal manager 100 may, between 5 PM and 5:30 PM, provide details of the second promotional offer data in response to receiving the unique FHV-offer code “123.” After 5:30 PM, the deal manager 100 may return to providing the first promotional offer data in response to receiving the unique FHV-offer code “123.” Thus, the deal manager 100 may advantageously provide a dynamic, interactive advertisement based on vendors' needs to consumers based on a single static ad placed on a FHV.

In other embodiments, the deal manager 100 may match received promotional offer data to the location of the consumer at the time the consumer entered the deal code. For example, the FHV 120 may display deal code “XYYV”, and may have no, or very little, information about what deal the code will provide. The deal manager 100 may receive first promotional offer data for theater tickets for a theater located at the intersection of Main and 1^{st} Street. The deal manager 100 may also receive second promotional offer data for a concert located at the intersection of Market St. and Park Ave. A first consumer may be 0.2 miles from Main and 1^{st} Street and 3 miles from Market St. and Park Ave. when the deal manager 100 receives the deal code “XYYV” from the first consumer. As a result, the deal manager 100 may respond with the first promotional offer data (the theater deal) since the first consumer is closer to the theater. A second consumer may be 4 miles from Main and 1^{st} St, but 0.5 miles from Market St. and Park Ave. when the deal manager 100 receives the deal code “XYYV” from the second consumer. As a result, the deal manager 100 may respond with the second promotional offer data (the concert deal) since the second consumer is closer to the concert.

In other embodiments, the deal manager 100 may match received promotional offer data to the location of the vehicle that displayed the deal code at the time the consumer entered the deal code. For example, FHV 120 may display deal code “A58”, and may display no, or very little, information about the deal provided to the consumer as a result of the entry of the deal code. The deal manager 100 may receive first promotional offer data for theater tickets for a theater located at the intersection of Main and 1^{st} Street. The deal manager 100 may also receive second promotional offer data for a concert located at the intersection of Market St. and Park Ave. At one point in time, the deal manager 100 may receive the deal code “A58” from a consumer when the FHV 120 is located 0.3 miles from the intersection of Main and 1^{st} Street and is located 2.9 miles from the intersection of Market St. and Park Ave. As a result, the deal manager 100 may provide the consumer with the details related to the first promotional offer (theater tickets) since the FHV 120 is closer to the theater. At a second point in time, the deal manager 100 may receive the same deal code “A58” from a consumer when the FHV 120 is located 4.2 miles from the intersection of Main and 1^{st} Street and is located 0.2 miles from the intersection of Market St. and Park Ave. The deal manager 100 may, in this case, provide the consumer with details related to the second promotional offer (the concert) since the FHV 120 is located closer to the location of the concert.

In other embodiments, once a deal manager 100 receives promotional offer data, the deal manager 100 may create an advertisement. In some embodiments, the advertisement may be in two parts. The first part of the advertisement may be a brief description of the offer or deal and the second part of the advertisement may be a more detailed description of the offer, along with an option to purchase the offer. For example, suppose a vendor wishes to offer a “buy 2 get 1 free” deal for tickets to its show “Circus of the Night.” The first part of the advertisement may be a teaser used to attract interest in the deal such as “Circus of the Night—Discount Tickets!!” The second part of the advertisement may include more details of the deal such as “Buy 2 tickets, get the 3^{rd} One Free! You can purchase 3 tickets for Circus of the Night NOW for $200 (regular price $300).” In other embodiments, the brief description may only be the name of the venue, show or entertainment option for which the deal is offered. For example, the brief description may only be “Circus of the Night.” In other embodiments, the brief description may only be the deal code. For example, the brief description may only be “Deal Code: 123.” As used herein, the term “brief description” may refer to descriptions on displays of FHVs that are unique FHV-offer code only (for example, “Deal Code: 999”) or descriptions on displays of FHVs that additionally include information about the deal being offered through the deal code.

By splitting the advertisement into two parts, the deal manager 100 advantageously provides vendors an opportunity to provide a brief description of a deal in order to attract interest, and to also provide more details of the deal and a purchase option to those consumers interested in the deal after viewing the brief description. In addition, the brief description also provides vendors the opportunity to attract interest in their deals using a medium where display space may be at a premium. For example, displays on the exterior of a vehicle may have limited space to display advertising information because the text of advertising may be need to be large to ensure that a viewer of the advertisement can read the information while the car is moving. In addition, the space for vehicle advertising may be limited to the size of the vehicle. For example, in the illustrative embodiment of FIG. 1B, FHV 120 has a display 111 that is affixed to the top of the FHV. So that intended targets may view the advertisement shown on display 111 from the sidewalk, while the FHV 120 is moving, the text of the advertisement may need to be large. Thus, by splitting the advertisement into two parts, the deal manager 100 advantageously allows a vendor to stimulate interest in the deal, but also provide greater detail once the brief description has stimulated the interest of the consumer.

Returning to FIG. 1A, in some embodiments, the deal manager 100 may be in communication with a printer. The printer may be a physical printer attached to the deal manager 100. The deal manager may send the printer several sets of brief descriptions for deals and unique FHV-offer codes that can be printed and affixed or attached to FHVs. In other embodiments, the printer may be a computer system of a third party service, such as advertising agency, that the deal manager 100 may send several unique FHV-offer codes. The advertising agency may then incorporate the unique FHV-offer codes into the mobile ad campaigns of their customers. In some embodiments, the printer may print a deal offer document 106. The deal offer document may include a brief description and a unique FHV-offer code. For example, the deal document 106 may have a brief description of “50% Off Concert Tickets” and it may have a unique FHV-offer code of “123,” as shown in the illustrative embodiment of FIG. 1A. The deal document 106 may be a paper document that can slide into a plastic cover on the exterior of FHV 120. In other embodiments, deal document 106 may have an adhesive back so that it may be attached to FHV 120.

In some embodiments, the deal document 106 may include more than one set of brief descriptions and unique FHV-offer codes. Each set of brief descriptions and unique FHV-offer codes may also have a unique FHV identifier, such as the FHV's VIN, medallion number or other identifier. The deal document 106 may then be used by a human operator to configure a static display by manually updating the display of each FHV listed in the deal document with the brief description and unique FHV-offer code associated with the FHV. A static display may include for example, a mechanical display where the operator physically turns one or more dials, gears, levels, knobs or other mechanical devices to spell out the brief description and unique FHV-offer code. In other embodiments, the static display may be a marquee style display with interchangeable letters or numbers. Static displays may also include posters, whiteboards, chalkboards, canvas, etc. Any means of displaying information may be used in conjunction with the data in the deal document 106 to advertise a deal using a brief description and a unique FHV-offer code.

The deal converter 140, in some embodiments, may execute an application that provides a means for a consumer to receive additional offer details or purchase offers. In some embodiments, the deal converter 140 may be a mobile computing device operated by consumer 141. The consumer 141 may execute an application that allows the consumer 141 to input a unique FHV-offer code corresponding to an offer presented by a FHV so that the consumer 141 may receive additional offer details pertaining to the brief description of the offer viewed by the consumer. One illustrative embodiment of the application is shown in FIG. 1A as application 150. The application 150 may comprise one or more user interface components, such as text fields, buttons, and drop down lists, for facilitating consumer input of deal codes. The application may leverage input methods available through the operating system executing on deal converter 140. For example, if the deal converter 140 is a mobile phone with a touch screen, the application 150 may facilitate user input through the touch events detected by the mobile phone operating system, or if the deal converter 140 is a mobile phone with a keypad, the application may facilitate user input through key down events detected by the mobile operating system. The application 150 may also communicate with the deal manager 100 using the existing interfaces available through the deal converter 140. For example, the application 150 may communicate with the deal manager 100 through the existing Wi-Fi port of the deal converter 140 (if the deal converter 140 is Wi-Fi enabled) or may use mobile telephone networks, or any other means of communicating between computing systems known in the art available on the deal converter computing device. (Wi-Fi is a mechanism for wirelessly connecting electronic devices. A smart phone which is Wi-Fi enabled can connect to the Internet via a wireless network access point or hotspot.)

Consumers may enter deal codes into the application 150 to receive additional details of a deal. For example, the consumer 141 may be on the street and see a FHV 120 displaying a deal. As shown in FIG. 1B, the FHV 120 may have a top affixed sign with a display that presents a brief description of an offer such as “50% off Concert Tickets” and a unique FHV-offer code of “123.” The consumer 141 may be interested in the deal and may launch the application 150 to get more details on the offer. After launching the application the consumer 141 may input the deal code into a text field 151 and press a user interface button 152 that commands the application 150 to send the data entered into the text field 151 to the deal manager 100. For example, the consumer 141 may enter “123” into text field 151. After the deal manager 100 receives the unique FHV-offer code, it may determine which offer corresponds to the FHV-offer code and send the deal converter 140, via the application 150, additional offer details. In other embodiments, the deal manager 100 may determine which deal to send to the deal converter 140 based on the location of the FHV 120 or the location of the consumer 141 and send the deal converter 140 the offer details associated with the deal. The consumer 141 may view the offer details and may choose to purchase the deal, thereby converting the advertisement into a sale.

In other embodiments, the application 150 may work with a camera or scanner installed in, or connected to, the deal converter 140. A consumer 141 may advantageously scan or take pictures of image based unique FHV-offer codes (for example, QR codes, UPCs, or other unique images) using the application. For example, when the consumer launches the application, there may be an option for the consumer to scan or take a picture of the imaged based unique FHV-offer codes. When the consumer selects the scan option, the application 150 may communicate with a camera or other image input device associated with the deal converter. In some embodiments, the application 150 may display a user interface that shows the input from the image input device and may allow the consumer to center the image input device on the image based, unique FHV-offer code. The application 150 may also have a button allowing the consumer 141 to capture the image. Once captured, the application 150 may automatically send the image to the deal manager 100, and the deal manager 100 may return deal details to the application 150. In other embodiments, the application 150, when launched, may automatically communicate with a camera or other image input device associated with the deal converter and provide the consumer 141 with an option of entering a deal code by capturing an image. The application 150 may then analyze the captured image and if the image contains a valid deal code (for example, the captured image contains a QR Code or the code can be ascertained using character recognition), the application 150 may communicate the deal code to the deal manager 100 and receive deal details. In other embodiments, the QR code may be read by a third party QR code reading application (for example, Google Goggles, ZXing, Kaywa) and may contain a URI (uniform resource identifier) pointing to the deal manager 100 and containing the deal code. The deal details may then be displayed in a web browser or the consumer's deal converter computing device. For example, a QR code may be scanned with the third party application and may correspond to the URI “http://dealmanager.website.com/dealcode=123”.

In some embodiments, the FHV 120 may provide basic instructions to the consumer 141 for acquiring the application 150 and to install the application 150 on the deal converter 140. The basic instructions, for example, may provide the name of the application 150 so that the consumer 141 may search the mobile application store of the consumer's choice for the application. For example, the application may be called “Deal Codes” and the consumer may search the Apple App Store™ or Android Market™ for an application named “Deal Codes.” In other embodiments, the deal presenter may provide a text message number or email address the consumer 141 may use to send a message to receive the application through short message service (SMS), email, or other messaging service. In another embodiment, the FHV 120 may provide a scannable image such as a QR code or UPC code that when photographed or scanned by the deal converter 140, a download of the application automatically begins.

In some embodiments, the application 150 may provide one or more user interfaces allowing a consumer to enter payment information. For example, the application 150 may provide a user interface allowing the consumer to enter a credit card number, debit card number, rewards card number, or some other form of payment to advantageously facilitate the purchase of deals. The application 150 may connect to the deal manager 100 via a secure connection such as a secure sockets layer (SSL) connection to securely communicate payment information to the deal manager 100. In other embodiments, the application 150 may launch a web browser on the deal converter 140 computing system and provide instructions to the web browser to load a web page that may be used by the consumer for payment of deals. For example, the application 150 may launch the web browser and provide instructions to URI such as “https://dealmanager.payment.com/dealcode=234.” The displayed webpage may then provide a user interface allowing the consumer to enter payment information. In some embodiments, the URI might point to a known third-party payment processor such as PayPal or a bank.

In other embodiments, the application 150 may advantageously store payment information of the consumer 141 so that purchasing details may occur with minimal input at the time of conversion and may facilitate ease of purchase. For example, the application 150 may have settings or a configuration screen where the consumer 141 may enter his credit card information. The application 150 may store the payment information in a data structure, file, or other data store so that it may be used for subsequent purchases. For example, the consumer 141 may download the application. Shortly after downloading and installing the application on his mobile device (deal converter 140) the consumer 141 may navigate to the application settings of configuration screen and enter his credit card information. After doing so, the consumer 141 may see a deal in which he interested. After providing the unique FHV-offer code to the application 150, the application may present additional details of the deal and may provide a button or other user interface widget that allows the consumer 141 to purchase the deal. In lieu of having the consumer 141 enter his payment information, the application may access the data structure to obtain the consumer's payment information to process payment for the deal. In some embodiments, as an additional security measure, when the consumer 141 attempts to save his payment information, the application may require the consumer 141 password protect the deal converter device, or the application may display a message suggesting the consumer 141 password protect the deal converter 140 device. In other embodiments, the application may require a username and password to access the application when payment information is stored. In some embodiments, the application 150 may direct the consumer 141 to a third party payment processor for processing payment, such as PayPal or a banking website, for example.

The application 150 may provide the consumer 141 with an opportunity to reserve a FHV in connection with the acceptance of a deal so that the consumer may have transportation to a deal. The application 150 may provide a user interface allowing the consumer to make the request at the time of acceptance of the deal or after payment has been processed. For example, the application 150 may provide a user interface containing the text: “Would you like a taxi to transport you to the Concert? If so, press ‘Reserve’ below, if not, press ‘No Thank You.’” When the consumer indicates they would like a FHV to transport them to the venue of the deal, in some embodiments the application 150 sends a message to the deal manager 100 with the current location of the consumer as provided by the deal converter (for example, by the deal converter's on board GPS). The deal manager 100 may then communicate with a reservation and dispatch computer system (not shown) to reserve a FHV to pick up the consumer at their current location. In other embodiments, the application 150 may communicate directly with a reservation and dispatch computer system to place the FHV reservation. Embodiments of methods for reserving FHVs in connection with the acceptance of deals is also described in applicant's co-pending application DISCOUNT OFFER SYSTEM AND METHOD FOR USE WITH FOR HIRE VEHICLES, application Ser. No. 13/249,027, filed Sep. 9, 2011, which is hereby incorporated by reference in its entirety.

In some embodiments, the application 150 may collect personal data about the consumer 141 that may be sent to the deal manager 100. The personal data may be used, among other things, by FHV owners to report demographic information about the consumers who purchase particular offers or to describe the consumers that are typically interested in the deals or purchase the deals. The personal data may also be used to match the consumer to target deals that may be offered through the application 150. For example, if a nightclub wanted to attract more females between the ages of 21-26, it may use the personal information to send a deal for discount drinks and a free cover to those consumers whose personal data fits the profile of females between the ages of 21-26. In addition, the collected personal data may also be used in conjunction with marketing information to target deals to consumers through their applications. For example, the deal manager 100 may collect data pertaining to the age, gender and marital status of consumers. The deal manager 100 may also have data indicating that married males and females between the ages of 28-35 are likely to have children. As a result, the deal manager 100 may target deals to the consumer in which may be of interest to children such as discounts to the zoo, for example.

In other embodiments, the personal data may be used by the deal manager 100 to determine which offer to send to the deal manager 100 after it receives a deal code, and the deal converter 100 may also use the location of the consumer to determine which offer details to send to the deal converter 100. For example, suppose the consumer 140 entered in personal data indicating that he is a sports fan. When the consumer 140 enters a deal code into the application and requests more information regarding the deal offered through the deal code, the application may also send the personal data of the consumer (such as the information that the consumer is a sports fan) and may also send the current location of the consumer using the GPS module of the deal converter. When the deal manager 100 receives the deal code and the consumer information, it may determine that a sports bar close to the consumer is currently offering a deal for discount food and beverage. The sports bar may have indicated that it would like the deal manager 100 to present offers to consumers that are sports fan and that are close to its venue. As a result, the deal manager 100 may send the offer details pertaining to the sports bar deal to the consumer in response to receiving the deal code.

In some embodiments, the application 150 may collect data about the consumer, for example, through a profile that the consumer may be required to fill out when installing the application on the deal converter 140. In another embodiment, the application may have an optional profile settings or configuration screen that may collect the personal data about the consumer. In other embodiments, the application may interface and/or communicate with other applications on the deal converter 140 that have exposed a data sharing application programming interface (API) for the application 150 to use to collect general data about the consumer. For example, a social networking site may have a mobile application that the consumer has installed on his mobile device (deal converter 140). The social networking mobile application may have data sharing API that shares some of the consumer's profile information with other applications executing on the deal converter computer system 140. The application 150 may access the consumer's profile information and send it to the deal manager 100.

The application 150, may also advantageously provide the consumer with the ability to receive incentives for entering deal codes. For example, a consumer may receive a point for each deal code entered, and after the consumer earns 10 points, the consumer may receive a free discount coupon. The incentive may also include, for example, an additional discount that may be applied to a deal the consumer would like to purchase. For example, the consumer, after entering 20 deal codes, may receive a $5 credit for any future deal purchased using the application. Later, when the consumer purchases a concert ticket deal for $20, the consumer's payment instrument (for example, credit card) may only be charged $15. In another embodiment, certain deal codes may reveal special prizes or discounts. For example, a local casino may wish to offer a promotion that the first consumer to enter four specific deal codes in her application earns a voucher for $250 in chips at the casino. Thus, consumers may be encouraged to enter several deal codes in order to earn the voucher thereby exposing the consumer to several deals. In some cases, vendors may work collaboratively in their promotions. For example the casino may offer the voucher, but when the consumer enters the deal codes to earn the voucher, they may be presented with deals for restaurants, shows, hotels, or other vendors working with the casino to promote their goods or services. In other embodiments, consumers may win a prize from a vendor when they enter a deal code at a particular time. For example, a hotel may normally offer a discount for a room, however, if a consumer enters the deal code for their deal at a particular time (for example, 5:15:32 PM on Dec. 1, 2011), the consumer may win a three night stay at the hotel. Thus, frequent and numerous entries of deal codes may be encouraged.

In other embodiments, the application 150 may interface with social networking sites or other applications that have a “check in” feature where the consumer may check-in to the application at various venues so that consumer preference information may be obtained regarding the consumer's preferences for entertainment, dining or lodging. For example, the application 150 may interface with the Foursquare™ Facebook® application. The consumer preference information may then be used to direct targeted offers related to the venues where the consumer “checked-in.” For example, a consumer may frequently check in at high-end French restaurants and may also check in at the Opera House. As a result, the deal manager 100 may send a targeted deal to the application to offer the consumer discounts for the high-end cuisine or operas and other classical music.

In some embodiments, the deal converter 140 may also collect past code entries and conversions of the consumer 141 to determine targeted deals. For example, if the consumer 141 often enters unique FHV-offer codes for deals to comedy clubs or purchases deals for comedy clubs, the deal manager 100 may send the consumer's application targeted deals for discounts to comedy clubs. In addition, if the consumer 141 often enters unique FHV-offer codes for deals for venues in a particular geographic location, the deal manager 100 may send targeted deals to the consumer's application for deals near that geographic location. For example, if the consumer is frequently entering unique FHV-offer codes for deals for venues on the Las Vegas Strip, the deal manager 100 may send targeted deals for discounts to casinos located on the Las Vegas Strip.

In some embodiments, the deal converter may not execute an application, but rather, the consumer 141 may request additional offer details and purchase an offer, through the SMS or other text messaging capabilities of the deal converter 140. For example, the deal presenter 110 may display a message such as “50% off Concert Tickets!!!, Text: ‘Deal code 123’ to 54321 for more details!” The consumer 141 may be interested in the deal and may text the string “Deal Code 123” to the number 54321. Here, the unique FHV-offer code is “123.” The deal manager 100 may then find additional details of the offer and send the following message back to the consumer's mobile device (deal converter 140): “Get two tickets for tonight's concert valued at $50 each for $25 each. Offer expires in 20 minutes. Reply with ‘Accept’ to buy the deal. You will be billed through your mobile service provider.” If the consumer 141 is interested in the deal, the consumer may reply with the “Accept.” Deal manager 100 will then reply with additional instructions for the consumer regarding using the purchased concert tickets.

It may be desirable, in some embodiments, to track the identity and/or location of the FHV 120 that displayed an advertisement of deal code at the time the consumer enters the deal code in the application 150 (when a consumer's interest in a deal was stimulated) or the time of conversion (when the consumer accepted and purchased the deal). The ability to collect and analyze the location at the time the code was entered (“code entry location”) and the location at the time of conversion (“conversion location”) advantageously provides FHV operators the ability to effectively market their advertising service and effectively realize revenue potential. For example, if a FHV operator knows that an intersection has a high code entry rate, the operator may charge higher interest rates for ads displayed at that location. The FHV operator may also use the number of conversions or the number of code entries as a means of marketing their service to potential advertisers. In some embodiments, FHV operators may determine locations of high interest or high conversion and may plan routes so that the FHVs frequently travel along those routes in order to maximize potential for ad views, code entries, and conversions.

In some embodiments, advertisers (that is, vendors or venue operators) may select, at the time they define their advertisement that their ads only be displayed or served from locations with high code entry rates or high conversion rates (“premium locations”). The advertisers may also be required to pay a higher advertising rate for advertising when the deal manager serves their ads in response to a deal code being entered from a premium location. Alternatively, advertisers may be charged a first rate when ads are served in response to a deal code received from a FHV in a non-premium location and a second, higher rate when its ads are served in response to a deal code received from a FHV in a premium location. In some embodiments, the deal manager 100 may serve ads from advertisers who pay a non-premium rate when the FHV is determined to be in a non-premium location and serve ads from other advertisers who pay a premium rate when the FHV is determined to be in a premium location.

In some embodiments, the deal manager 100 may track code entries and conversions using a unique FHV-offer code that is associated with a FHV and that provides an identification mechanism for identifying the source of the FHV for the entered code or the conversion. In some embodiments, the code is unique to a FHV and offer combination. For example, an offer for a discount coupon to restaurant may be displayed on three different FHVs, FHV 1, FHV 2 and FHV 3. The deal manager 100 may then create a first unique FHV-offer code for the restaurant offer displayed on FHV 1, such as “ABC,” a second unique FHV-offer code for the restaurant offer displayed on FHV 2, such as “XYZ,” and a third unique FHV-offer code for the restaurant offer displayed on FHV 3, such as “RST.” Also, for example, a FHV may display two offers, one for a comedy show discount coupon, and another for a voucher for a room at a casino-hotel. The deal manager 100 may then create a first unique FHV-offer code for the comedy show, such as “4A4” and a second unique FHV-offer code for the room at the hotel-casino. As described herein, the unique FHV-offer code may be used by a consumer to request additional information (that is, the “detailed description”) by inputting the FHV-offer code into an application 150 executing on deal converter 140. In other embodiments, the FHV-offer code may be unique to the FHV, but the offer may change for the FHV-offer code. For example, as described above, a FHV displaying a FHV-offer code may be advertising a first deal at a first time and a second deal at a second time using the same FHV-offer code. The FHV-offer code, however, would still be unique to the FHV thereby allowing the deal manager 100 to attribute a consumer code entry or a conversion to a particular FHV.

The FHV-offer code, in some embodiments, may be a string of characters that can be inputted through the use of tactile or virtual keyboard or keypad such as “ABC,” “12ZZ456”, “!!@456,” “DealCode#,” for example. In other embodiments, the FHV-offer code may be an image that can be scanned or photographed by deal converter 140. For example, the FHV-offer code may be a UPC code, QR code, or other symbol that allows for enough combinations to provide for unique codes to be associated with each offer-FHV combination registered with the deal manager 100. In some embodiments, the FHV-offer code may be displayed in more than one format at time. For example, the FHV-offer code may be displayed alphanumerically (“ABC123”) and as an image (QR Code). In some embodiments, the image FHV-offer code may advantageously processed by a standard or common applications available on most mobile device platforms such as photo applications, text messaging applications, email client applications and/or web browser applications. For example, the photo application may take a digital photograph of the image FHV-offer code and the consumer may be able to text or email the image to deal manager 100. Deal manager 100 may then send a web page link back to the consumer containing information about the deal. Alternatively, the mobile device application may decode the photographed image, extract the FHV-offer code, and send just the FHV-offer code to the deal manager 100 or a website hosted by the deal manager 100.

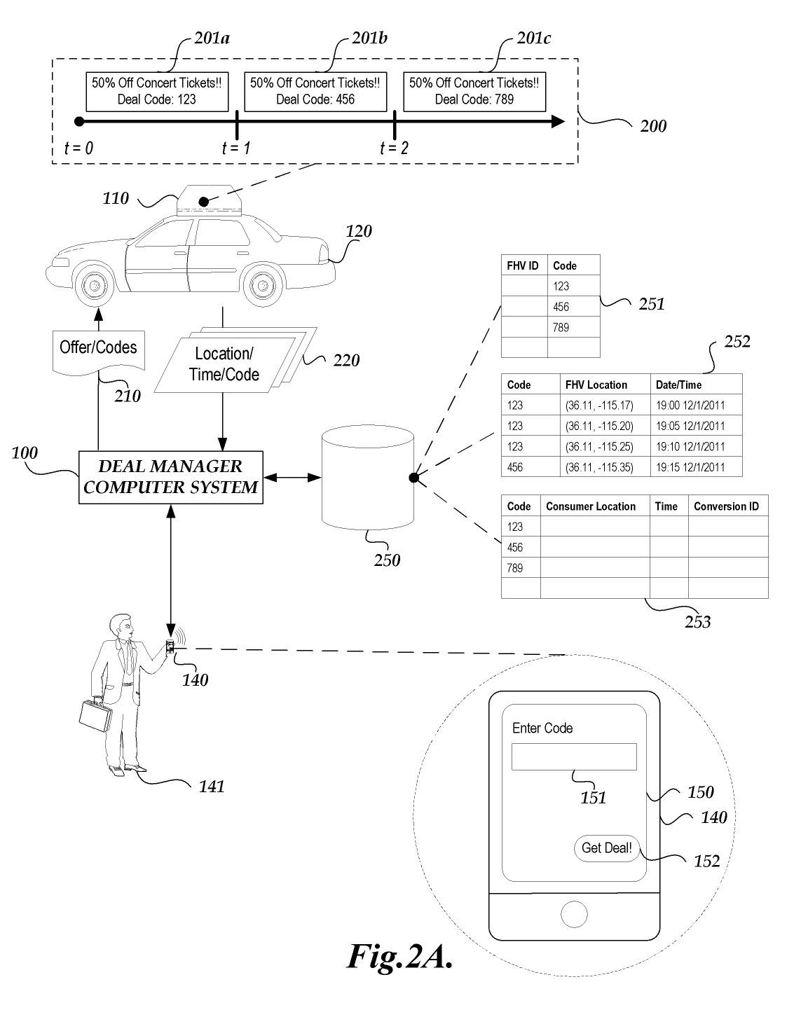

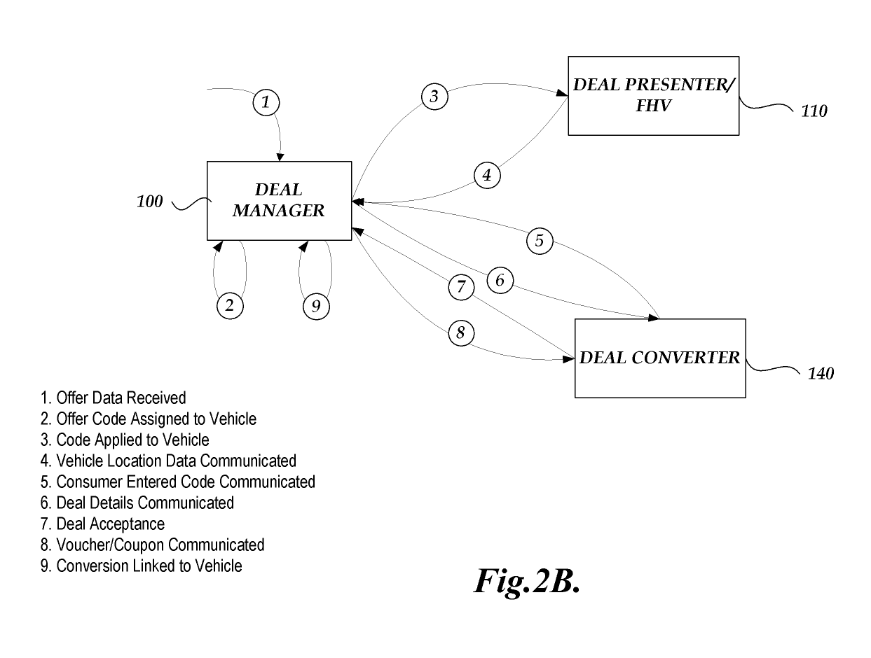

Code entry locations and conversion locations may be advantageously determined by the deal manager 100 through the use of FHV-offer codes sent to the deal manager 100 (which may advantageously have a website interface) and location information reported by the FHV 120. In some embodiments, the FHV 120 may have a geospatial location unit, such as a GPS receiver, that determines the current location of the FHV and transmits time, location, and identifier information to the deal manager 100 on a periodic basis, such as every second. When the deal manager 100 receives a FHV-offer code, as either the result of code entry or a conversion, the deal manager 100 may analyze the code to determine the FHV associated with the code. The deal manager 100 may also look at the time of interest, or the time of conversion, and look for received location data for the determined FHV at that time, thereby revealing the FHV's interest location or conversion location. For example, the deal manager 100 may receive a FHV-offer code of “123” at 19:32:33 on Dec. 1, 2011. The deal manager 100 may determine that the FHV-offer code of “123” corresponds to the FHV with serial number “1FMHP72WOA11111.” The deal manager 100 may then look up the location of the FHV with that serial number, reported by the FHV at 19:32:33 on Dec. 1, 2011 and determine that it the FHV was at the coordinates “36°, 10′, 33.6″ N, −115°, 8′ 13.2″ W” (approximately 3600 South Las Vegas Blvd, Las Vegas, Nev.). Additional examples of how deal presenter 110 may determine interest locations and/or conversion locations based on received location data and unique FHV-offer codes is described in more detail with respect to FIGS. 2A-2B.

FIG. 1B illustrates one embodiment of a deal manager computer system 100 in communication with a deal presentation computer system 110 and a deal conversion computer system 140. In one embodiment, the deal manager computer system (“deal manager”) 100 manages advertisements, deals or offers (“deals”) that may be communicated to the deal conversion computer system (“deal converter”) 140. The deal manager 100 may also associate a unique FHV-offer code with a FHV that it may include in the deals that are communicated to the deal presenter 110 or the deal converter 140. The deal presenter 110, in some embodiments, advantageously comprises a display that shows deals received from the deal manager 100. The deal presenter 110 may be affixed to the exterior of the for-hire vehicle (“FHV”). For example, in the illustrative embodiment of FIG. 1B, the deal presenter is affixed to the roof of the FHV 120 as a “for-hire vehicle top” or “taxi top” display.

In some embodiments, the deal presenter 110 may be a computer system that displays advertisements for offers. The deal presenter 110 may command a display 111 to show a brief description of an advertisement for an offer along with a FHV-offer code. For example, in the embodiment of FIG. 1A, the deal presenter 110 commanded the display 111 to show a brief description 112 of “50% Off Concert Tickets” and a unique FHV-offer code of “123.” In some embodiments, the brief description and the FHV-offer code are received from the deal manager 100 over a wireless network. In other embodiments, the deal presenter 110 may be programmed by an operator with the brief description and the FHV-offer code. For example, the deal presenter 110 may have a keyboard or other input device that advantageously allows an operator to program the deal presenter 110 with the brief description and the unique FHV-offer code. In another embodiment, the deal presenter 110 may be programmed with a separate computing device connected to the deal presenter 110. For example, the deal presenter 110 may have a port, such as USB port or RS 232, that an operator may use to connect the separate computing device, login in to the deal presenter 110 (for example, through a telnet session) and issue commands to the deal presenter 110 including the brief description of the offer and the unique FHV-offer code.

In some embodiments, such as the illustrative embodiment of FIG. 1B, the deal presenter 110 is affixed to the exterior of the FHV. For example, the deal presenter 110 may be a FHV-top or taxi-top display. In other embodiments, the deal presenter 110 may be affixed to the door, fender, real panel or trunk or other body panel of the FHV. In other embodiments, the deal presenter 110 may be affixed to the interior of the FHV, but may be viewable from outside of the FHV 120. For example, the deal presenter 110 may be attached to the rear seat of the FHV 120 and may be viewable through the rear window of FHV 120. The deal presenter 110 may be attached, connected or part of the FHV 120 in any position which advantageously facilitates the display of offers so that consumers may be able to view the brief description of the offer and the unique FHV-offer code.

In some embodiments, the display 111 of deal presenter 110 is dynamic, that is, the display 111 may computerized or digitized and may change based on configurations or conditions. For example, FIG. 2A illustrates one embodiment where the display changes based on a periodic time increment. FIG. 1B illustrates one example of a dynamic display. The deal manager 100 may send offer information to deal presenter 110 which then advantageously shows the offer information (such as, for example, the brief description and the unique FHV-offer code). In other embodiments, such as the illustrative embodiment of FIG. 1A discussed above, the display 111 may be static, that is, the display may not be computerized and may be fixed to a particular brief description and FHV-offer code.

In some embodiments, a brief description may be published to a FHV display. The illustrative embodiment of FIG. 1A shows a deal presenter 110 that comprises a FHV display 111. The display 111 of FIG. 1A is configurable and may be controlled by the deal presenter 110. Deal presenter 110 may be computer system that receives deals from the deal manager 100 and sends commands to the display 111 instructing it to display the brief description of the advertisement. The display 111 may be, for example, an LCD display, CRT display, LED display, or some other dynamically configurable display. Although the illustrative embodiment of FIG. 1B shows a dynamic display 111, controlled by a deal presenter 111 in communication with a deal manager 100, the brief description of the advertisement may be static (such as paper or decal) as described above with respect to FIG. 1A and may include the deal code.

FIG. 1C is a block diagram illustrating the temporal flow of data for one embodiment of a deal manager computer system 100 that is in communication with a deal presentation computer system 110 and/or FHV 120, and a deal conversion computer system 140. In particular, the circled numerals of FIG. 1C illustrate the order in which data flows between the various components of FIG. 1C according to one embodiment. In other embodiments, the steps outlined by the circled numerals may be performed in a different order, and the embodiment may include fewer or additional steps. In addition, although the illustrative embodiment of FIG. 1C shows each of deal manager 100, deal presenter 110 or deal converter 140 as one block, deal manager 100, deal presenter 110 or deal converter 140 may be more one or more computer systems performing the functions described herein with respect to each block.

Generally, the temporal flow of data starts with step 1 where the deal manager 100 receives promotional offer data or information from a vendor. In some embodiments, the promotional offer data may be received through a web site provided by the deal manager 100. In other embodiments, it may be received through a data file or data object sent by a computer system operated by the vendor and in communication with deal manager 100. In other embodiments, vendors may call, email or otherwise contact an operator of deal manager 100 that inputs the promotional offer information into the deal manager 100 using an interface directly connected to the deal manager 100. Some examples of embodiments describing how promotional offer data may be received by the deal manager 100 are described in applicants' co-pending application DISCOUNT OFFER SYSTEM AND METHOD FOR USE WITH FOR HIRE VEHICLES, application Ser. No. 13/249,027, filed Sep. 9, 2011, which is hereby incorporated by reference in its entirety.

Once the deal manager 100 receives the promotional offer data, the deal manager at step 2 assigns a unique FHV-offer code to each FHV registered with the deal manager for the promotional offer data. The unique FHV-offer code is a code, as described above, that may be entered by a consumer to receive additional details about an offer advertised by a deal presenter that is installed, affixed or otherwise associated with a FHV. In some embodiments, the deal manager 100 generates the FHV-offer code randomly, and assigns the FHV-offer code to a registered FHV if the randomly generated code has not already been assigned to a FHV. For example, the deal manager 100 may randomly generate three digit FHV-offer codes using a pseudo-random number generator that is well known in the art. The first code it may generate is “123” and it may then assign “123” to a first registered FHV. The second code it may generate is “456.” The deal manager 100 may first search to determine if “456” has been assigned to a FHV. Since it has not, the deal manager 100 assigns “456” to the second registered FHV. As the deal manager 100 generates random, three-digit codes, it may randomly generate “123.” The deal manager 100 will then search for “123” and determine that it has already been assigned. Since it has, it will generate another random number to assign.

In some embodiments, the FHVs that can display advertisements are registered with the deal manager 100. The registration may include, for example, an identification number associated with the FHV. The identification number may be a unique identification number that can be used to determine the exact FHV on which the ad is displayed. For example, the identification number may be the serial number of the FHV, the medallion number of the FHV, or some other regulatory assigned identification number that may be used to uniquely identify the FHV. FHVs may be registered with the deal manager through a configuration file that lists all of the identifiers of the FHV. The configuration file may, for example, be a ASCII text file, XML file, or some other file format commonly used to configure computer systems. In other embodiments, the FHVs may be registered through a user interface where an operator types the FHV identification information in to the system.

By way of example, suppose that for step 2, four FHVs are registered with the deal manager 100: FHV A, FHV B, FHV C and FHV D. The deal manager 100 receives promotional offer data for a 40% off coupon for admission to a comedy club for $3. The comedy club vendor provided a brief description of the advertisement as “Discount Comedy Tickets!!!” The deal manager 100 may create an advertisement for display on the FHV that includes the brief description along with a generated, assigned unique FHV-offer code. The deal manager 100 may generate four FHV-offer codes for each of the four registered FHVs: “111,” “222,” “333,” and “444,” and assign FHV A code “111,” FHV B code “222,” FHV C code “333,” and FHV D code “444.”

In step 3, the deal information is published to the deal presenter 110 or FHV 120. The term “published” as used herein refers to the process of transferring deal information from the deal manager 100 to the deal presenter 110 (or FHV 120). Publishing may occur over a network, for example. The network may be any combination of one or more LANs, WANs, or the Internet, and may also include ad-hoc peer-to-peer networks, such as, for example, ports for sending and receiving data between computer systems such as a USB port or an RS 232 port. Publishing may also occur without the use of a network or a computer system at the FHV 120. For example, publishing may include an operator writing a brief description of a deal and a unique FHV-offer code on a whiteboard attached to the FHV, or attaching a poster to the FHV. In some embodiments, the deal information published to the deal presenter 110 or the FHV 120 may be the minimum deal information needed to stimulate interest in the deal and provide enough data so that a consumer may request additional information concerning the deal. For example, the deal information may include a brief description of the deal and a unique FHV-offer code. In some embodiments, the brief description may only be the unique FHV-offer code. As described above, the unique FHV-offer code may be used by consumer to retrieve additional deal details.

At step 4, the deal manager 100 receives a deal code from a deal converter 140 and may, in some embodiments, also receive location and time information. When the deal manager 100 receives a deal code, the receipt serves as notice that a consumer is interested in a deal. In some embodiments, the received deal code is a unique FHV-offer code that was displayed on a FHV. Since the unique FHV-offer code is unique to the FHV the deal manager 100 may use the code to determine the FHV that displayed the deal and in embodiments where the FHV-offer code is unique to an offer determine the offer or deal that stimulated the consumer's interest. In some embodiments, the deal converter 140 provides additional information to the deal manager 100, such as location and time information. In some embodiments, the deal converter 140 will determine location information from a geospatial-location unit that is part of, or is connected to, the deal converter 140 such as GPS chip or module. In some embodiments, time information is determined based on the operating system time of the deal converter. In other embodiments, the time information may be determined from the geospatial-location unit. In addition to the deal code, location information and time information, the deal converter 140 may also communicate an identifier associated with the deal converter. The identifier may be a hardware identifier, such as a Media Access Control (“MAC”) address, or it may be a unique serial number associated with the application 150 executing on the deal converter 140. In other embodiments, the identifier may be a random code generated by the deal manager 100 when it receives the deal code and it may be passed back and forth during the deal acceptance process (steps 4-7 of FIG. 1C).

At step 5, additional details of the deal may be sent to the deal converter 140. The additional details may be the detailed description of the deal. The detailed description may describe what the object of the deal, the venue where the deal may be redeemed, and the cost of the deal. For example, a detailed description might be “Buy 1 Steak Get One Free! at Super Steak, $5” (the object, venue and cost respectively). The additional details may also include an option to purchase the deal.

In some embodiments, the consumer may enter payment information (such as a credit card number for example) using a payment information user interface generated by the application 150 that is executed by the deal converter 140. In other embodiments, the deal converter may send stored payment information to the deal manager 100. In some embodiments, payment information is not sent by the deal converter directly, but the deal converter may direct the consumer to a third-party payment processor which in turn communicates with the deal manager to process payment for the deal.

In some embodiments, the consumer may also, at step 5, have the option of requesting a FHV to transport him to the location of the deal. For example, if the deal is being offered for a concert located at 125 Main St., and the consumer is not located within walking distance of 125 Main St. the consumer may request that a FHV be reserved and dispatched.

At step 6, acceptance of the deal and payment details are received by the deal manager 100 from the deal converter, thereby converting the deal to a sale. The acceptance, in some embodiments, may include an indication that the deal was accepted, as well as location, time and/or identification information at the time of acceptance (as described with respect to step 4). If the consumer has requested a FHV, the deal manager may reserve a FHV using the location provided by the deal converter. The deal manager 100 may then place a reservation with a for-hire vehicle reservation and dispatch computer system (not shown) to pick up the consumer at the provided consumer location and transport him to the location of the deal. Embodiments where FHVs are reserved and dispatched in connection with the acceptance of a deal are described in more detail in applicant's co-pending application DISCOUNT OFFER SYSTEM AND METHOD FOR USE WITH FOR HIRE VEHICLES, application Ser. No. 13/249,027, filed Sep. 9, 2011, which is hereby incorporated by reference in its entirety. The payment details may include the consumer's credit card information. The deal manager 100 may then process the payment. When the deal manager 100 is through processing the payment, it may then send a receipt to the deal converter, or in other embodiments, may send a voucher that may be redeemed at the venue offering the deals at step 7. The receipt or voucher may be sent to the application 150 of the deal converter 140, or in other embodiments may be sent to the consumer via email, text message, or regular mail postal mail if time allows. The mechanism for communicating receipts and vouchers may be configured by the consumer through the application 150, or in other embodiments may default to the mechanism used for communicating interest in the deal and converting the deal. For example, if the consumer used the application to show interest and convert the deal, the receipt or voucher may be sent to the deal converter through the application, or if the consumer used text messaging to show interest and convert the deal, the receipt or voucher may be sent via text message. Embodiments of the contents of receipts and voucher, as well as examples of ways vouchers may be redeemed, are described in more detail in applicant's co-pending application DISCOUNT OFFER SYSTEM AND METHOD FOR USE WITH FOR HIRE VEHICLES, application Ser. No. 13/249,027, filed Sep. 9, 2011, which is hereby incorporated by reference in its entirety.

At step 8, the deal manager 100 attributes the conversion to the FHV that originally displayed the deal and may also determine the location of the FHV and/or the consumer at the time of interest and at the time of conversion. The deal manager 100 advantageously uses the unique FHV-offer code associated with the converted deal to determine which FHV displayed the deal that triggered the conversion. In embodiments where the FHV periodically reports location information, the location of the FHV at the time of interest and at the time of conversion may be determined by comparing the interest time received from the deal converter to the location of the FHV at that interest time. A similar approach may be taken to determine the conversion location. In embodiments where the FHV does not periodically report its location, the location information received from the deal converter 140 at the time of interest and the time of conversion may be used as an approximate location of the FHV.

FIG. 2A illustrates one embodiment of a deal manager computer system 100 in communication with a deal presenter computer system 110 and a deal converter computer system 140. In the embodiment of FIG. 2A, the FHV 120 is provided with a set of unique FHV-offer codes 210 and the deal presenter 110 displays the offer codes in accordance with a configured, timed increment. Each member of the set of unique FHV-offer codes 210 is a unique code assigned to one FHV and one offer. Thus, while the deal presenter 110 is provided with more the one unique FHV-offer code, each of the codes maps to only one FHV and to only one offer so that the deal manager 100 may be able to determine the offer and the FHV corresponding to each code. The deal presenter 110 commands its display 200 to show one of the unique FHV-offer codes at time, but the display 200 may change on a periodic basis. For example, in the embodiment of FIG. 2A, the deal presenter 110 is showing a deal for 50% off concert tickets. At time t=0, the deal presenter 110 is displaying a first deal code 201a of “123.” Once time t=1 occurs, the deal presenter 110 changes its display to show a second deal code 210b of “456.” At time t=2, the deal presenter changes its display to show a third deal code 201c of “789.” The deal presenter 110 may then periodically and continuously change the displayed deal code to another code received in the set of unique FHV-offer codes 210.

In the embodiment of FIG. 2A, the FHV 120 periodically and continuously reports location data 220 describing location, time and displayed unique FHV-offer code 220 (such as 201a, 201b, and 201c) of the FHV 120 to the deal manager computer system 100. As the deal manager computer system 100 receives the location data 220, it may store the data in a data store 250. In some embodiments, the data store 250 may include a table 252 that corresponds to the received location data 220. For example, the table 252 may include columns corresponding to the displayed code, the location of the FHV with the code was displayed by the FHV's deal presenter, and the time the location data was determined and the code displayed. The rows of table 252 may correspond to the location data 220 received at one time. For example, in the embodiment of FIG. 2A, table 252 the first row of data indicates that code “123” was displayed on a FHV a location “(36.11, −115.17)” (36° 6′ 35.9994″, −115° 10′ 12″) at time “19:00.” Although the time column of FIG. 2A displays hours and minutes only, the time may include the calendar date, seconds, tenths of seconds, or hundredths of seconds as needed in particular embodiments. Any format for representing a date and time may be used in various embodiments of table 252.

As in the embodiments described above, then when the consumer 141 has interest in a deal displayed by deal presenter 110, the consumer 141 may enter the displayed deal code into the application 150 of the deal converter 140. Data in the form of the entered code, the consumer location at the time the consumer entered the code and the time consumer entered the code may then be communicated to the deal manager 100. Once the deal manager 100 receives the interest data, the deal manager 100 may store the data store 250. In some embodiments, the data store 250 may include a table 253 that corresponds to the received location data. For example, the table 253 may include columns corresponding to the entered code, the location of the consumer when he entered the code, and the time the consumer entered the code. The table 253 may also contain a column (Conversion ID) linking the data to a separate table of conversion data (not shown).

When the deal manager 100 determines the location of the FHV 120 at the time the deal code was entered and at the time of conversion, the deal manager may reference table 253 to determine the code entered by the consumer and the time they entered the code. The code and the time may then be used to determine the FHV location using the data store in table 252. The deal manager 100 may also be able to determine the FHV that displayed the deal that generated a consumer interest and conversion by referencing table 251 which contains a mapping of FHVs registered with the deal manager 100 (as described above) and their associated unique FHV-offer codes.

FIG. 2B is a block diagram illustrating the temporal flow of data for one embodiment of a deal manager computer system 100 that is in communication with a deal presentation computer system 110 and/or FHV 120, and a deal conversion computer system 140. In particular, the circled numerals of FIG. 2B illustrate the order in which data flows between the various components of FIG. 2B according to one embodiment. In other embodiments, the steps outlined by the circled numerals may be performed in a different order, and the embodiment may include fewer or additional steps. In addition, although the illustrative embodiment of FIG. 2B shows each of deal manager 100, deal presenter 110 or deal converter 140 as one block, deal manager 100, deal presenter 110 or deal converter 140 may be more one or more computer systems performing the functions described herein with respect to each block. Furthermore, many of the steps of FIG. 2B are the same as, or substantially the same as, the steps described with respect to FIG. 1C.

Generally, the temporal flow of data starts with step 1 where the deal manager 100 receives promotional offer data or information from a vendor. Once the deal manager 100 receives the promotional offer data, the deal manager at step 2 assigns a unique FHV-offer code to each FHV registered with the deal manager for the promotional offer data. In step 3, the deal information is published to the deal presenter 110 or FHV 120.

At step 4 the deal manager 100 receives location data describing the FHV's location, the displayed unique FHV-offer code shown by deal presenter 110 and the time (including the calendar date) the code was displayed. As noted above, the location data may be received periodically and continuously. For example, the location data may be received every second, every 10 seconds, every 15 seconds, every minute or any other time period that may provide the appropriate level of granularity to determine the location of the FHV at the time of interest or the time of conversion.

At step 5, the deal manager 100 receives a deal code from a deal converter 140 and may, in some embodiments, also receive location and time information. At step 6, additional details of the deal may be sent to the deal converter 140. At step 7, acceptance of the deal and payment details are received by the deal manager 100 from the deal converter, thereby converting the deal to a sale. The deal manager may also process the received payment information. When the deal manager 100 is through processing the payment, it may then send a receipt to the deal converter, or in other embodiments, may send a voucher that may be redeemed at the venue offering the deals at step 8. At step 9, the deal manager 100 attributes the conversion to the FHV that originally displayed the deal and may also determine the location of the FHV and/or the consumer at the time of interest and at the time of conversion.

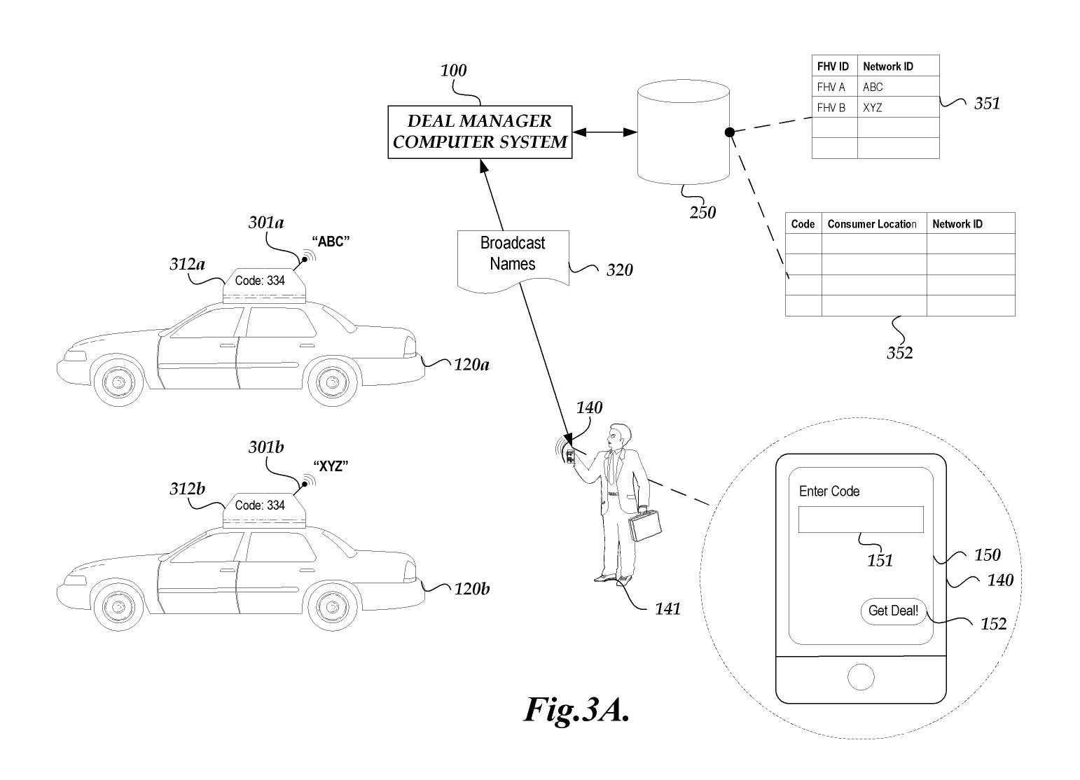

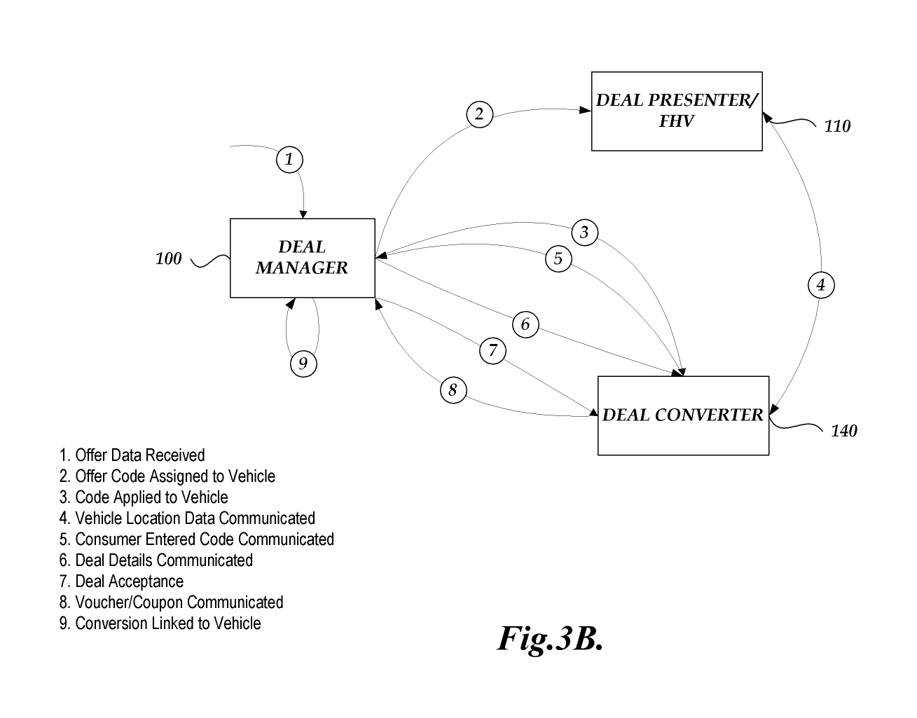

FIG. 3A illustrates one embodiment of a deal manager computer system 100 in communication with a deal converter computer system 140. The deal converter computer system 140 may be in-communication with one or more FHVs 120a, 120b. In the embodiment of FIG. 3A, the FHVs 120a, 120b are configured with a wireless network or Wi-Fi hotspot 301a, 301b. In some embodiments, each FHV presenting deals broadcasts a Wi-Fi connection using a unique network name, network identifier, or service set identifier (SSID) (“broadcast name”). As the broadcast names are unique for a FHV for a region of operation, or a system of FHVs, the broadcast name may be used to identify a particular FHV within in the system. For example, if the broadcast name “FHV_Wifi_1025” is used by the Wi-Fi of FHV 1025, no other FHV would use the broadcast name “FHV_Wifi_1025.” Thus, if a user of a computer were to discover a mobile Wi-Fi network associated with the broadcast name “FHV_Wifi_1025,” the user would be able to determine that they connected to FHV 1025's hotspot.

In some embodiments, the broadcast names of the FHVs are maintained by deal manager 100 in data store 250. Data store 250 may maintain a table 351 associating a FHV identifier (such as the FHV's VIN, medallion number, or other identifier) with the broadcast name of the FHV. For example, table 351 has a first column for a FHV identifier and second column for a broadcast name (“Network ID”). In the embodiment of FIG. 3A, table 351 has a row for FHV A 120a indicating that it uses the broadcast name “ABC” and a row for FHV B 120b indicating that it uses the broadcast name “XYZ.” In some embodiments, the list of available broadcast names 320 is communicated to the deal converter 140. The list of available broadcast names 320 may be formatted as a text file, serialized data object, XML file, byte stream, or any other data format used to communicate data between computing systems.

In one embodiment, the FHVs 120a, 120b display an advertisement, offer or deal 312a, 312b. The advertisement may have a deal code that can be used by consumers to find out more details of the deal or to purchase the deal. The deal code may be unique to a particular offer or deal, but is not necessarily unique to the FHV that is displaying the deal. For example, in the embodiment of FIG. 3A, FHV 120a and FHV 120b are both displaying the same deal code, “334.” If a consumer is interested in finding out more about the deal, or would like to purchase the deal, the consumer may use the deal converter 140 to send the deal code to the deal manager 100.

Although FHV 120a and 120b are illustrated in FIG. 3A as only displaying one deal code, in other embodiments more than one deal code may be displayed. For example, an FHV may have display two deals: (1) an offer for 35% off karate lessons and (2) discount show tickets. Since the FHV is displaying two deals, it will also display two deal codes. For example, the karate lessons deal might be associated with deal code “198” and the show tickets might be associated with “902.” A consumer may select either deal for more information or for purchase by entering the associated deal code into the deal converters 140.

In one embodiment, the deal converter 140 may execute a continuous background process that searches for the available broadcast names. Upon discovery of one of the available broadcast names, the deal converter 140 may alert the consumer 141 and inform him that a FHV hotspot was detected. The deal converter 140 may also ask the consumer if he would like to launch application 150 to enter deal codes and view the detailed description of the deal being offered by the FHV via the hotspot. If the consumer is interested in the deal, the deal converter 140 may launch the application 150 and may, in some embodiments, pre-populate text field 151 with the deal code associated with the deal offered over the hotspot. In embodiments where the FHV is displaying more than one deal code, the application 150 may display, in lieu of text field 151, an option selector user interface component pre-populated with the deal codes being displayed by the FHV. The option selector user interface component may be a drop down list, a radio button group, a check-box group, or a list selector, for example. In such embodiments, the deal presenter 110 may communicate the deal codes to the application 150 through the hotspot. For example, the application 150 may have an application programming interface (API) that has an interface accepting an array of deal code strings, and the deal presenter 110 may send an array of strings of the deal codes it is displaying. In other embodiments, other means of communicating data between computing systems may be used to communicate the deal codes from the deal presenter to the deal converter. Upon receipt of the deal codes, the application 150 may render the user interface for selecting the deal codes using the deal code identifiers received from the hotspot.

In another embodiment, the deal converter 140 may execute a continuous background process that searches for the available broadcast names. Upon discovery of one of the available broadcast names, the deal converter 140 may automatically launch the application 150 and display an advertisement or details of a deal. The consumer 141 may then view the displayed advertisement and accept and pay for the deal. Thus, a consumer 141 may receive multiple deals when standing in the same location as one or more FHVs with hotspots drive past the consumer. For example, a consumer may be waiting at a red light at a busy intersection. When a first FHV drives past the consumer, it may have a hotspot with the name “FHV1_network.” The application 150 may have “FHV1_network” in its list of available network names and may, as a result, establish a connection with the “FHV1_network.” The application 150 may then receive a first advertisement over the network. A brief moment later as the consumer is still standing at the same intersection, a second FHV may drive past the consumer with a hotspot of the name “FHV2_network.” The application 150 may have “FHV2_network” in its list of available network names and may, as a result, establish a connection with the “FHV2_network.” The application 150 may then receive a second advertisement over the network that is different from the first advertisement. In some embodiments, the first advertisement may contain a first deal code uniquely identifying the first FHV and the second advertisement may contain a second deal code uniquely identifying the second advertisement. When a consumer accepts the deal offered in either the first advertisement or the second advertisement, the associated deal code may be advantageously communicated to the deal manager 100. In some embodiments, the deal code may be displayed by the application, but in other embodiments, it may be hidden from the consumer. Further if the FHV drives away such that the hotspot connection is lost the application may advantageously automatically transfer the connection to the deal website to another internet service (for example another Wi-Fi hotspot in range or through a cellular service provider) so that any transaction that the consumer may want to enter into may be completed.

When the consumer 141 submits a deal code to the deal manager 100, additional data may be sent with the deal code so that the deal manager 100 may advantageously associate the consumer interest or the consumer conversion with the FHV displaying the deal. The additional data may also assist the deal manager 100 in determining the approximate location of the FHV when the consumer viewed the deal that initiated the interest or resulted in a conversion. In some embodiments, the additional data may include the broadcast name of the network with which the deal converter connected. For example, in the illustrative embodiment of FIG. 3A, if the deal converter 140 connected to hotspot 301b of FHV 120b, the additional data may include the broadcast name “XYZ.” The additional data may also include location information of the deal converter 140 when the consumer selected the button 152 to send the deal code to the deal manager 100. The location information may be obtained from a geospatial location unit that is part of, or attached to, the deal converter 140. Sending the location information of the geospatial location unit allows the deal manager 100 to approximate the location of the FHV that displayed the deal. Since the mobile Wi-Fi hotspots are limited in range, and the broadcast name of each hotspot is unique, the deal manager 100 may determine the identity and location of the FHV displaying the deal through the combination of broadcast name and the location information of the deal converter 140, thereby alleviating the need for each FHV to send location information on a periodic basis to the deal manager 100. In other embodiments, the FHVs may not periodically send location information, but rather, the deal manager 100 may contact the FHV's computing system for its location substantially immediately or as soon as reasonably possible (for example within one to four seconds) upon the receipt of the broadcast name matching the identity of the FHV. Further it may be advantageous to periodically send location information and to contact the FHV for location when consumer activity is detected.

In some embodiments, the deal manager 100 may persist deal codes and their associated additional data in the data store 250. The data store 250 may include, for example, a table 352 that has columns representing a deal code, the consumer location and a broadcast name. When the deal manager 100 receives a deal code and associated additional information, it may add a row to table 352 with the received data. The deal manager 100 may then use the rows of the table 352 and the rows of the table 351 to identify the FHV that displayed the deal, and determine the approximate location of the FHV when the consumer connected to the FHV's hotspot and entered the deal code. For example, for one row in table 352, the deal manager 100 may associate a row in table 351 with the same network ID value. Then using the information in table 351, the deal manager 100 may be able to determine the FHV ID of the FHV displaying the deal. The deal manager 100 may also use the consumer location data as an approximate location for the FHV. In other embodiments, once the deal manager 100 determines the FHV ID of the FHV displaying the deal, it may “ping” or contact the FHV for its location data, thereby determining the location of the FHV at the time the consumer entered the deal code.

FIG. 3B is a block diagram illustrating the temporal flow of data for one embodiment of a deal manager computer system 100 that is in communication with a deal presentation computer system 110 and/or FHV 120, and a deal conversion computer system 140. In particular, the circled numerals of FIG. 3B illustrate the order in which data flows between the various components of FIG. 3B according to one embodiment. In other embodiments, the steps outlined by the circled numerals may be performed in a different order, and the embodiment may include fewer or additional steps. In addition, although the illustrative embodiment of FIG. 3B shows each of deal manager 100, deal presenter 110 or deal converter 140 as one block, deal manager 100, deal presenter 110 or deal converter 140 may be more one or more computer systems performing the functions described herein with respect to each block. Furthermore, many of the steps of FIG. 3B are the same as, or substantially the same as, the steps described with respect to FIG. 1C.

Generally, the temporal flow of data starts with step 1 where the deal manager 100 receives promotional offer data or information from a vendor. Once the deal manager 100 receives the promotional offer data, the deal manager at step 2 assigns a unique FHV-offer code to each FHV registered with the deal manager for the promotional offer data. In step 3, the deal manager 100 pushes the list of available network identifiers to the deal converter 140. The network identifiers correspond to the broadcast names that are broadcast by the FHVs 120 that are currently operating. In some embodiments, the list of available network identifiers is not pushed out to the deal converter 140 until the consumer launches the application 150 for entering deal codes in response to the stimulation of consumer interest in an advertisement. In another embodiment, the application may utilize a background process that continuously listens for updates to the list of available network identifiers.

Once the consumer launches the application 150, the application may begin to search for available wireless networks by searching for broadcast names that match the names of available network IDs provided by the deal manager 100. Once the application finds one broadcast name that matches one of the available network IDs, the deal converter 140 may advantageously establish a connection with the deal presenter via the SSID at step 4. Once the connection is established, the deal converter 140 may access one or more offer codes available through that network. The application may then advantageously display the codes thereby allowing the consumer the ability to select one of the codes so that the consumer may obtain further information about the deal

At step 5, the deal manager 100 receives a deal code from the deal converter 140 and may, in some embodiments, also receive location and time information. At step 6, additional details of the deal may be sent to the deal converter 140. At step 7, acceptance of the deal and payment details are received by the deal manager 100 from the deal converter, thereby converting the deal to a sale. The deal manager may also process the received payment information. When the deal manager 100 is through processing the payment, it may then send a receipt to the deal converter, or in other embodiments, may send a voucher that may be redeemed at the venue offering the deal at step 6. At step 9, the deal manager 100 attributes the conversion to the FHV that originally displayed the deal and may also determine the location of the FHV and/or the consumer at the time of interest and at the time of conversion.

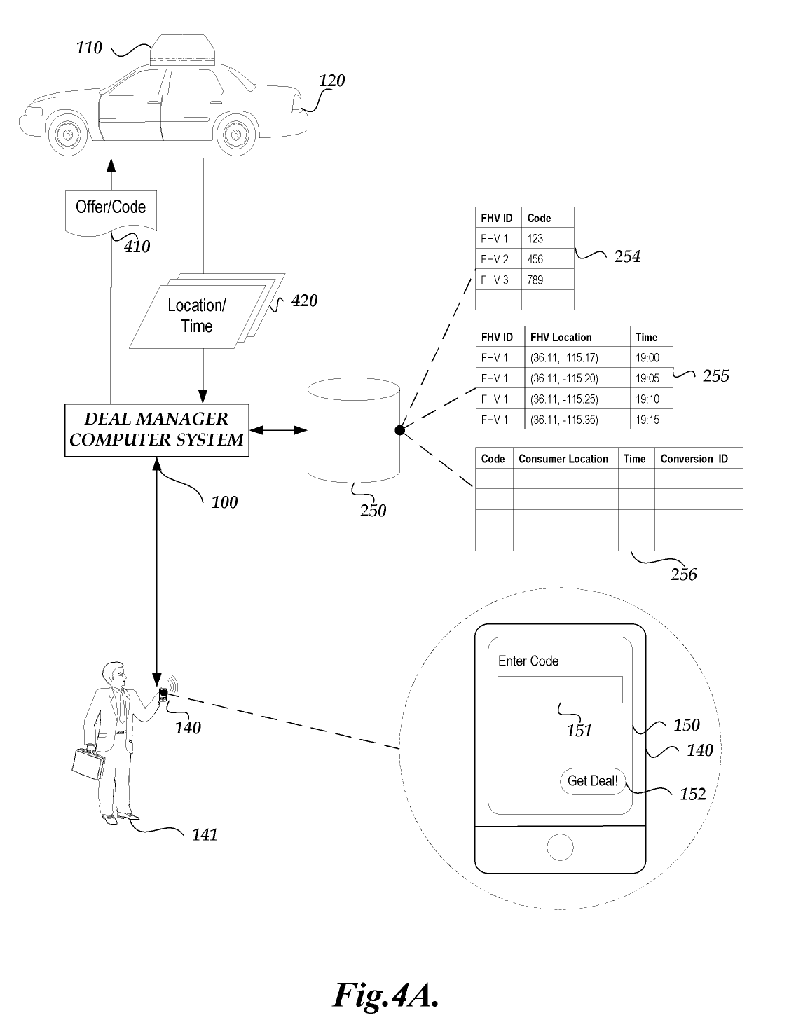

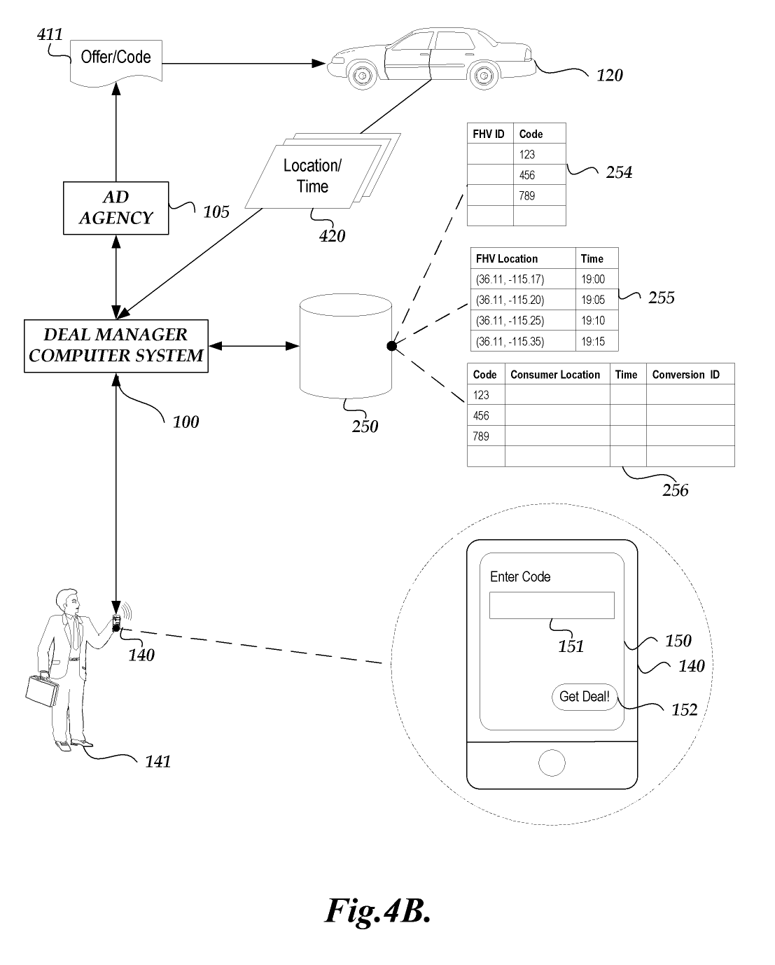

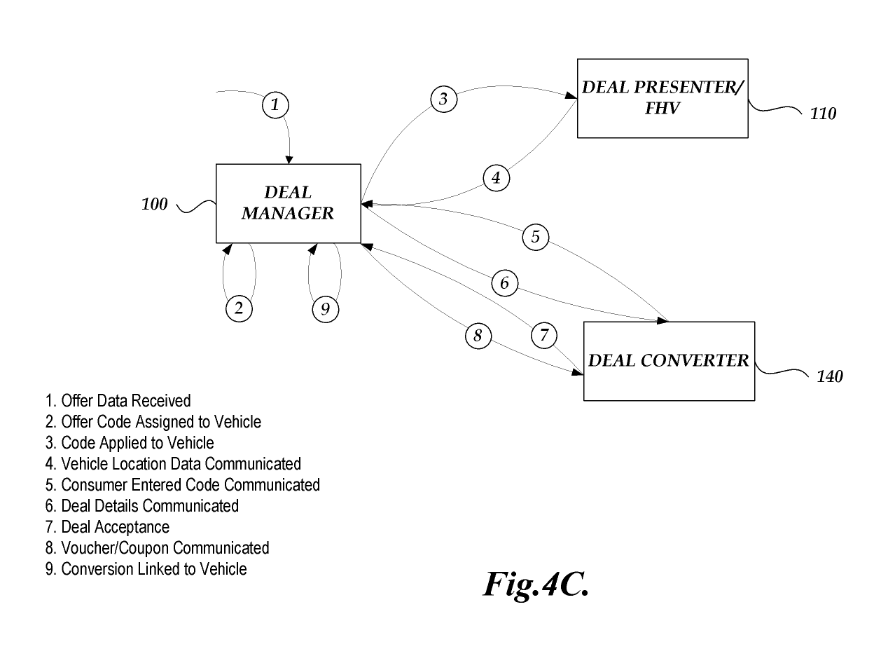

FIG. 4A illustrates one embodiment of a deal manager computer system 100 in communication with a deal presentation computer system 110 and a deal conversion computer system 140. The illustrative embodiment may advantageously allow vendors offering deals through mobile advertising on FHVs to gather data providing an indication of the general distribution of the geographic impact of the offer on each FHV displaying deal codes linking to their offers. In FIG. 4A, a FHV 120 may include a deal presenter 110 that displays a unique FHV-offer code 410. The deal presenter 110 may display a brief description of a deal that is offered by a venue along with the unique FHV-offer code 410. When a consumer 141 is interested in a offer displayed on deal presenter 110, it may use deal converter 140 that is executing application 150. The application 150 may provide a user interface that advantageously allows the consumer 141 to enter the unique-FHV code so that the consumer may receive additional offer details and pay for the offer, if the consumer desires to pay for the deal.

It may be desirable, in some embodiments, to determine the location of the consumer 141 and/or the location of the FHV 120 at the time of the consumer enters the deal code and at the time of conversion (that is, when the consumer buys the deal). The deal manager 100 may determine these locations based on independent location data received from the FHV 120 (or in some embodiments, the deal presenter 110) and the deal converter 140. The deal manager 100 may receive consumer location data from the deal converter 140 at the time of code entry and at the time of conversion. For example, the applications 150 executing on the deal converter 140 may utilize the geospatial recognition module of the deal converter 140 to determine the current location of the deal converter 140. For example, the application 150 may communicate with a GPS chip or module of the deal converter 140 or may communicate with a “location services” API of the operating system of the deal converter 140. The deal manager 100 may also receive FHV location data periodically. The deal manager may use the unique FHV-offer code provided by the deal converter to determine which FHV's advertisement stimulated interest in the deal. Once the FHV is determined, the deal manager 100 may then analyze the location data received from that FHV and compare the times the location data was recorded with the time the deal code was entered or the time of conversion to determine the location of the FHV. For a particular FHV, several code entry locations and/or several conversion locations may be determined. By examining the aggregate of code entry locations and conversion locations for a FHV, the geographic impact for an offer may be advantageously determined.

In some embodiments, the deal manager 100 generates a unique FHV-offer code for deals it may receive from vendors. As it generates unique FHV-offer codes, it may store an association between the FHV to which the offer will be deployed and the unique FHV-offer code in data store 250. In some embodiments, the data store 250 may include a table 254 that has a first column for a FHV identifier (“FHV ID”) and a second column for the unique FHV-offer code (“Code”). Once the code is generated, the deal manager 100 may send an offer/code message 410 that contains the unique FHV-offer code and a brief description of the offer to the deal presenter 110 that is attached, affixed or associated with the FHV 120. Once the deal presenter 110 receives the message, it may display the brief description of the offer and the unique FHV-offer code.

In the illustrative embodiment of FIG. 4A, the deal manager 100 determines the location of the FHV 120 at the time of interest or the time of conversion based at least in part on one or more location messages 420 received from the FHV. The FHV may periodically report its location through the location messages 420. For example, the location messages 420 may be sent to the deal manager 100 every second, minute, or other time interval that may provide for effective location determination of the FHV 120 during the periods it is displaying deal codes and at the time of code entry and/or the time of conversion. In some embodiments, the deal manager 100 may be in communication with a data store 250. The data store may include a table 255 that has columns for an identification value of the FHV (“FHV ID”), a reporting location of a FHV (“FHV Location”) and a reporting time (“Time”). As the deal manager 100 receives the location messages 420, it may add the data from the messages to the data store 250 and the data may be persisted as rows in the table 255.

FIG. 4B illustrates one embodiment of a deal manager computer system in communication with a deal conversion computer system. In the embodiment of FIG. 4B, an ad agency may generate an offer/code document 411 that may be affixed to or otherwise displayed in a FHV 120. The ad agency's interface with the FHV and the deal manager is the same or similar to the description provided above with respect to FIG. 1A. For example, the ad agency may create static displays that include the unique FHV-offer codes. The codes could be stickers placed on mass printed ads, or in other embodiments, an individual ad may be printed for each FHV. The offer/code document 411 may contain a brief description of an offer and a unique FHV-offer code that is unique to the FHV-offer combination. When a consumer 141 is interested in a offer displayed on deal presenter 110, it may use deal converter 140 that is executing application 150. The application 150 may provide a user interface that advantageously allows the consumer 141 to enter the unique-FHV code so that the consumer may receive additional offer details and pay for the offer, if the consumer desires to pay for the deal.

The illustrative embodiment of FIG. 4B determines the locations of the FHV and consumer at the time of the deal code was entered and time of conversion in the same, or substantially the same, manner as the illustrative embodiment of FIG. 4A. That is, the deal manager 100 determines the locations based on independent location data received from the FHV 120 and the deal converter 140. The deal manager 100 may receive consumer location data from the deal converter 140 at the time of interest and at the time of conversion. The deal manager 100 may also receive FHV location data periodically. The deal manager may use the unique FHV-offer code provided by the deal converter to determine which FHV's advertisement stimulated interest in the deal. Once the FHV is determined, the deal manager 100 may then analyze the location data received from that FHV and compare the times the location data was recorded with either the time of interest or the time of conversion to determine the location of the FHV.

FIG. 4C is a block diagram illustrating the temporal flow of data for one embodiment of a deal manager computer system 100 that is in communication with a deal presentation computer system 110 and/or FHV 120, and a deal conversion computer system 140. In particular, the circled numerals of FIG. 4C illustrate the order in which data flows between the various components of FIG. 4C according to one embodiment. In other embodiments, the steps outlined by the circled numerals may be performed in a different order, and the embodiment may include fewer or additional steps. In addition, although the illustrative embodiment of FIG. 4C shows each of deal manager 100, deal presenter 110 or deal converter 140 as one block, deal manager 100, deal presenter 110 or deal converter 140 may be more one or more computer systems performing the functions described herein with respect to each block. Furthermore, many of the steps of FIG. 4C are the same as, or substantially the same as, the steps described with respect to FIG. 1C.

Generally, the temporal flow of data starts with step 1 where the deal manager 100 receives promotional offer data or information from a vendor or an advertising agency. Once the deal manager 100 receives the promotional offer data, the deal manager at step 2 assigns a unique FHV-offer code to each FHV registered with the deal manager for the promotional offer data. In step 3, the deal information is published to the deal presenter 110 or FHV 120.

At step 4 the deal manager 100 receives location data describing the location, time and displayed unique FHV-offer code shown by deal presenter 110. As noted above, step 4 may be performed periodically and continuously. For example, step 4 may be performed every second, every 10 seconds, every 15 seconds, every minute or any other time period that may provide the appropriate level of granularity to determine the location of the FHV at the time of interest or the time of conversion.

At step 5, the deal manager 100 receives a deal code from a deal converter 140 and may, in some embodiments, also receive location and time information. At step 6, additional details of the deal may be sent to the deal converter 140. At step 7, acceptance of the deal and payment details are received by the deal manager 100 from the deal converter, thereby converting the deal to a sale. The deal manager may also process the received payment information. When the deal manager 100 is through processing the payment, it may then send a receipt to the deal converter, or in other embodiments, may send a voucher that may be redeemed at the venue offering the deals at step 8. At step 9, the deal manager 100 attributes the conversion to the FHV that originally displayed the deal and may also determine the location of the FHV and/or the consumer at the time of interest and at the time of conversion.

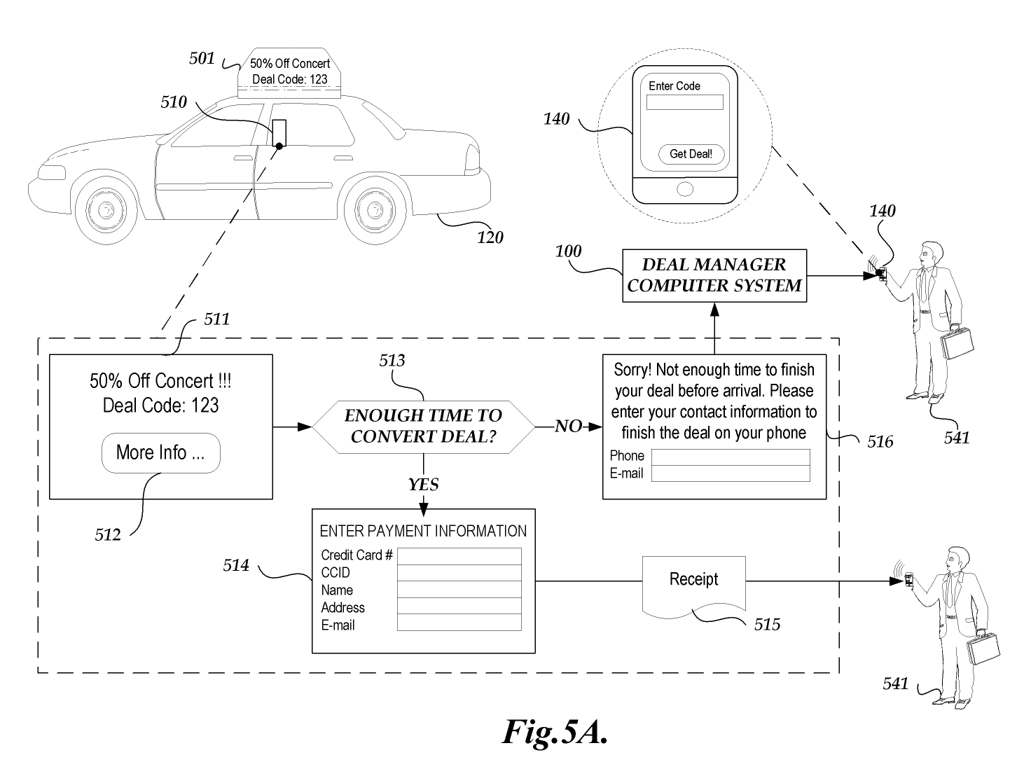

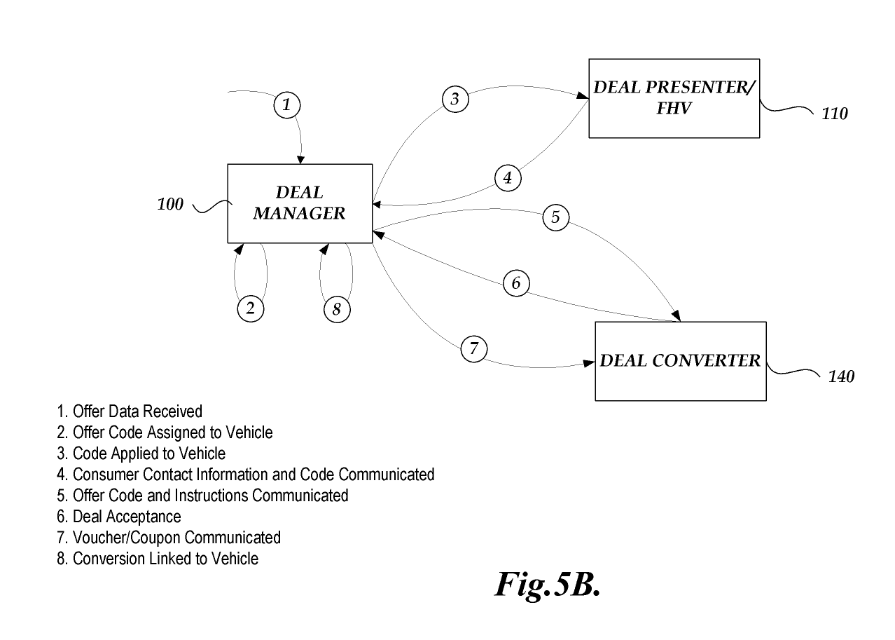

FIG. 5A shows one embodiment of a FHV 120 that including two embodiments of a deal presentation computer system: one embodiment affixed to the roof of the FHV 120, rooftop deal presenter 501, and another embodiment affixed to the interior of the FHV 120, interior deal presenter 510. Although the illustrative embodiment of FIG. 5A shows a FHV with both a rooftop deal presenter 501 and an interior deal presenter 510, other embodiments of FHV 120 may have only one of the rooftop deal presenter 501 or the interior deal presenter 510.

In some embodiments, the interior deal presenter 510 provides substantially the same function as the other embodiments of deal presenter 110 discussed herein. For example, the interior deal presenter 510 may display brief descriptions of deals and may also display unique FHV-offer codes or deal codes. In other embodiments, the interior deal presenter 510 may provide additional functionality that would not be needed, or may prove impractical for, rooftop implementations. For example, the interior deal presenter 510 may include an input device thereby allowing the passenger to interact with the deal presenter. In some embodiments, the interior deal presenter 510 may comprise an interactive screen that provides passengers the ability to request more details of offers while riding in the FHV. The interactive screen may be a touch screen, for example. The interactive screen may also be a screen that accepts input the use of a stylus, mouse, trackball or other input device. In some embodiments, the interior deal presenter 510 may allow a passenger to request a detailed description of a deal and also pay for the deal. The interior deal presenter 510 may also comprise, or be connected to, a point-of-sale terminal (“POS terminal”). The POS terminal may be a credit/debit card swipe device including a magnetic strip reader, or it may comprise a keypad to allow for credit/debit cards. In other embodiments, the POS terminal may be part of or simply use the existing POS terminal of the FHV that is used by the driver of the FHV to accept passenger fares. The POS terminal may be any commercially available device (including appropriate point of sale supporting software) for accepting and processing payments and capable of installation within a FHV. For example, the POS terminal may be a terminal provided by a well-known provider of POS terminals such as VeriFone.

An illustrative example in operation of the embodiment of FIG. 5A may start with a passenger 541 hiring FHV 120 for a trip. While riding in the FHV 120, rooftop deal presenter 501 and interior deal presenter 510 may be displaying the brief description of a deal. For example, in the embodiment of FIG. 5A, both rooftop deal presenter 510 and interior deal presenter 510 are displaying a brief description of a deal for 50% off a concert. Although the embodiment of FIG. 5A shows rooftop deal presenter 510 and interior deal presenter 510 displaying the same deal, in other embodiments, rooftop deal presenter 510 and interior deal presenter 510 may each display different deals. The interior deal presenter 510 of FIG. 5A comprises a touchscreen (or other well known screen user input combination) that displays the brief description of the deal in a user interface 511. The user interface 511 may also contain a button 512 that the passenger may touch to get more information about the deal. In some embodiments, the user interface 511 may also contain a text area or text field that would allow the passenger to enter the deal code, or unique FHV-offer code, associated with the deal. In other embodiments, the unique FHV-offer code may be displayed, but the passenger need not enter the code. In other embodiments, the deal code may not be shown to the passenger, but may still be associated with the deal programmatically. The deal code may then be transmitted in a message to the deal manager 100 when the passenger provides the input indicating he wishes to get more details of the deal.

In some embodiments, when the passenger selects the button 512 to get more information, the interior deal presenter 510 may determine, at box 513, whether there is enough time to convert the deal to a sale. The interior deal presenter 510 may make this determination by comparing the average time it takes to complete a deal to the estimated time left in the passenger's trip. For example, when the average time to complete a deal is 60 seconds, and the trip is estimated to take an additional 100 seconds, the interior deal presenter 510 will determine that there is enough time to complete the deal and may display user interface 514 requesting the passenger to enter their payment information. When, however, the average time to complete the deal is 60 seconds, and the trip is estimated to take an additional 30 seconds, the interior deal presenter 510 will determine there is not enough time to complete the deal and may display user interface 516, requesting that the passenger enter their contact information so that the deal may be completed using the passenger's mobile computing device.

In some embodiments, when the interior deal presenter 510 determines there is enough time to complete the deal while the passenger is in the FHV 120, it will display user interface 514. The user interface 514 may include one or more text fields for the passenger to enter payment information. In another embodiment, the user interface 514 may provide instructions for the passenger to use an attached POS terminal to complete the deal. For example, the user interface may instruct the passenger to swipe his credit/debit card or to enter payment card information using a keypad or other input device. The user interface may also, in some embodiments, ask for the passenger to enter an email address or phone number so that the passenger may receive a receipt 515 or a voucher for the deal. In other embodiments, the interior deal presenter 510 may include a printer that prints a receipt and/or voucher once the passenger pays for his deal. Once the passenger enters the payment information, the payment information may be sent to the deal manager computer system 100 for processing. Once the payment is processed, the deal manager computer system 100 may generate a receipt 515. The receipt 515 may include information about how the passenger may redeem, or “cash-in”, his recently purchased deal. After the deal manager computer system 100 generates the receipt, it may send it to the contact address or phone number provided by the passenger using the user interface 514.

In other embodiments, when the interior deal presenter 510 determines there is not enough time to complete the deal while the passenger is in the FHV, the interior deal presenter 510 may offer the passenger the option to complete the deal using the passenger's mobile computing device. In such embodiments, the interior deal presenter 510 may display a user interface 516 to facilitate the passenger entering his contact information. The user interface 516 may provide text fields for the passenger to enter his phone number or e-mail address (or both). Once the passenger enters his contact information into user interface 516, the contact information may be sent to the deal manager computer system 100. The deal manager computer system 100 may then contact the passenger 541 using the contact information and provide instructions to the passenger for accepting the deal. For example, if the passenger provided an email address, the deal manager computer system 100 may send an email to the passenger with the unique FHV-offer code of the deal and a link the passenger may use to download the mobile application 150 (described above with respect to FIG. 1A). Alternatively, for example, the deal manager computer system 100 may send the unique FHV-offer code to passenger via a text message sent to the passenger's phone number. The text message may also contain a URL or other indicator of where the passenger may download the mobile application 150. Once the passenger downloads and installs the application 150, the passenger may enter the unique FHV-offer code, to get more details on the deal and purchase the deal, if the passenger desires. The operation of entering the unique FHV-offer code, receiving more deal details, paying for the deal, and receiving a deal voucher and/or receipt would be the same or substantially the same as other embodiments described herein.

In some embodiments, the deal manager computer system 100 may generate a new code in response to receiving the contact information from the user interface 516 of the interior deal presenter that is unique to a passenger-FHV-offer combination. The code may then be used by the passenger to complete the payment process using his mobile computing device without the need to download an application to the consumer's mobile computing device. For example, the deal manager 100 may provide a website that advantageously provides a user interface for entering a unique passenger-FHV-offer combination code so that the passenger may complete the payment process through the use of the web site. Through the use of the unique passenger-FHV-offer combination code, the deal manager 100 may advantageously associate the interest in an offer, to an individual passenger, to a particular FHV.

FIG. 5B is a block diagram illustrating the temporal flow of data for one embodiment of a deal manager computer system 100 that is in communication with a deal presentation computer system 110 and/or FHV 120, and a deal conversion computer system 140. In particular, the circled numerals of FIG. 5B illustrate the order in which data flows between the various components of FIG. 5B according to one embodiment. In other embodiments, the steps outlined by the circled numerals may be performed in a different order, and the embodiment may include fewer or additional steps. In addition, although the illustrative embodiment of FIG. 5B shows each of deal manager 100, deal presenter 110 or deal converter 140 as one block, deal manager 100, deal presenter 110 or deal converter 140 may be more one or more computer systems performing the functions described herein with respect to each block. Furthermore, many of the steps of FIG. 5B are the same as, or substantially the same as the steps described with respect to FIG. 1C. The following paragraphs provide more detail on those steps that may be different from FIG. 1C.

Generally, the temporal flow of data starts with step 1 where the deal manager 100 receives promotional offer data or information from a vendor. Once the deal manager 100 receives the promotional offer data, the deal manager at step 2 assigns a unique FHV-offer code to each FHV registered with the deal manager for the promotional offer data. In step 3, the deal information is published to the deal presenter 110 or FHV 120. As described above with respect to FIG. 5A, the deal may be published to a deal presenter on the exterior of a FHV 120 and/or to a deal presenter on the interior of the FHV 120.

At step 4, the deal manager 100 receives contact information about a passenger. The contact information may be a phone number, email, social networking address, or some other contact information specifying where the passenger may be contacted electronically. Along with the contact information, the deal manager 100 may, in some embodiments, also receive a unique FHV-offer code. Once the deal manager 100 receives the contact information, it may, in some embodiments, determine if the contact information matches a registered consumer. If the deal manager 100 finds a consumer that matches the contact information, it may send, at step 5, a message (formatted appropriately for the contact information, that is, email message of the contact information is an email address) to the deal converter of the passenger comprising the unique FHV-offer code and an instruction to enter the unique FHV-offer code into the consumer's application 150. When the deal manager 100 does not find a consumer that matches the contact information, it may send, at step 5, one or more contact messages to the consumer. The contact messages may include information about where the consumer may obtain, download and/or install an application that may be used to receive more deal details or to pay for deals. The contact messages may also include the unique FHV-offer code and an instruction to enter the unique FHV-offer code into the consumer's application.

At step 6, acceptance of the deal and payment details are received by the deal manager 100 from the deal converter, thereby converting the deal to a sale. The deal manager may also process the received payment information. When the deal manager 100 is through processing the payment, it may then send a receipt to the deal converter, or in other embodiments, may send a voucher that may be redeemed at the venue offering the deals at step 7. At step 8, the deal manager 100 attributes the conversion to the FHV that originally displayed the deal and may also determine the location of the FHV and/or the consumer at the time of interest and at the time of conversion.

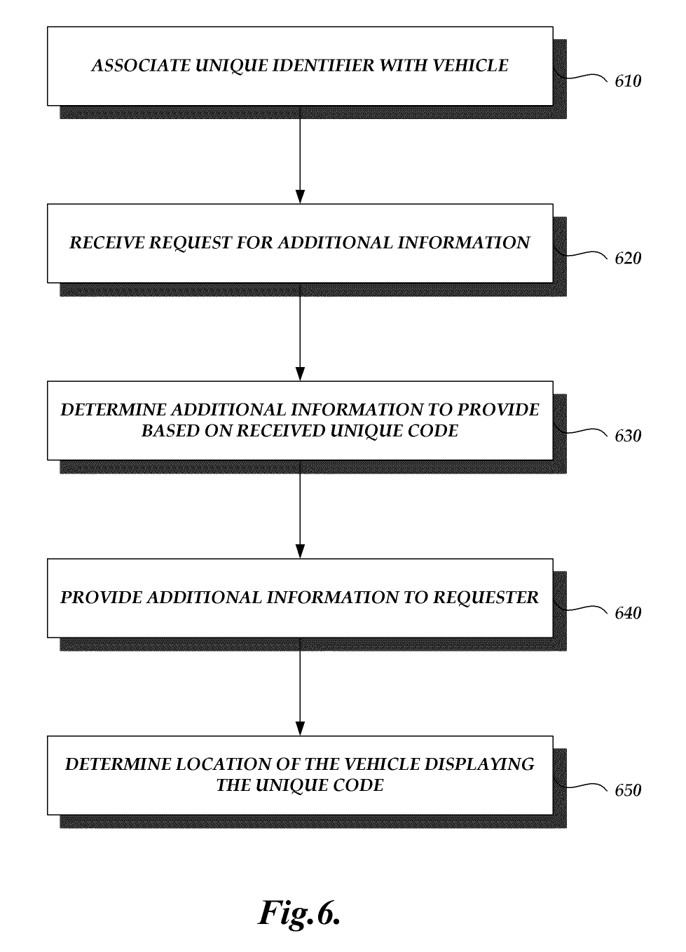

FIG. 6-10 show flowcharts illustrating several process flows for various embodiments of the current disclosure. Although the process flows illustrated in FIGS. 6-10 are depicted as being preformed in a particular order, the steps of the illustrated process flows may be performed in a different order in various embodiments. In addition, the process flows depicted in FIGS. 6-10 may describe the process flow for one or more of the embodiments of FIGS. 1-5, however, no process flow is meant to correspond to any specific embodiment of FIGS. 1-5 in particular. When describing the process flow of FIGS. 6-10, any reference made to any of FIGS. 1-5 is for illustrative purposes only and one skilled in the art will understand that any of the other non-referred to embodiments of this disclosure may also apply to any of FIGS. 6-10.

FIG. 6 is a flowchart illustrating a process flow for advertising using a vehicle displayed advertisement in one embodiment of a deal manager computer system. Beginning in box 610, the deal manager computer system may associate a unique identifier with a vehicle. The unique identifier may be representative of an offer and be uniquely assigned to a vehicle. The unique identifier, may, in some embodiments, be part of an advertisement. For example, the unique identifier may be “ABC” and be part of an advertisement that says “Discount Tickets, Offer Code: ABC” that is displayed on or by the vehicle. In other embodiments, the unique identifier may uniquely identify a vehicle, but may not be associated with a particular advertisement, offer, or deal. In such an embodiment, the unique identifier may be displayed on a vehicle, such as a for-hire vehicle. For example, the unique identifier may be a numeric code such as “645”, or it may be, in other embodiments, an image, such as a QR code, for example.

In box 620, the deal manager 100 may receive a request for additional information. The request may include, as described throughout this specification, a unique identifier associated with a vehicle. The unique identifier may have been entered by a consumer through an application executing on the consumer's computing device, such as a mobile computing device, laptop or tablet, for example. In other embodiments, the request for additional information may also include location information of the consumer. The location information may be obtained from the consumer's computing device using the geospatial location mechanism of the device such as a GPS chip, for example. Next, in box 603, the deal manager 100 determines what additional information to provide to the requesting consumer based on the received unique code. In some embodiments, the unique code corresponds to a particular advertisement, and in such embodiments, the deal manager 100 may provide additional information for the advertisement corresponding to the received unique code. In other embodiments, the deal manager 100 may determine what additional information to provide to the requester based on the received location information or through some other means as described throughout this specification. Once deal manager 100 has determined what additional information it will provide, it provides it to the requester at box 640.

Next, in box 650, the location of the vehicle displaying the received unique code is determined based at least in part on the receive unique code. The deal manager 100 may determine this information by using the request for additional information received at box 620. For example, the deal manager 100 may determine which vehicle displayed the unique code based on the unique code received from the consumer (as a code is uniquely associated with a vehicle) and may determine that vehicle's location using the consumer location information received in the request, since the consumer is likely to be close to the vehicle at the time the consumer sends the code to the deal manager. In other embodiments, such as the embodiments described with respect to FIGS. 2A and 4A, location information may be received from the vehicle displaying the unique code. In such embodiments, the deal manager may determine the location of the vehicle by matching the code received from the consumer with a vehicle, then finding the received location information from the vehicle that is closest in time to when the deal manager 100 received the information from the consumer.

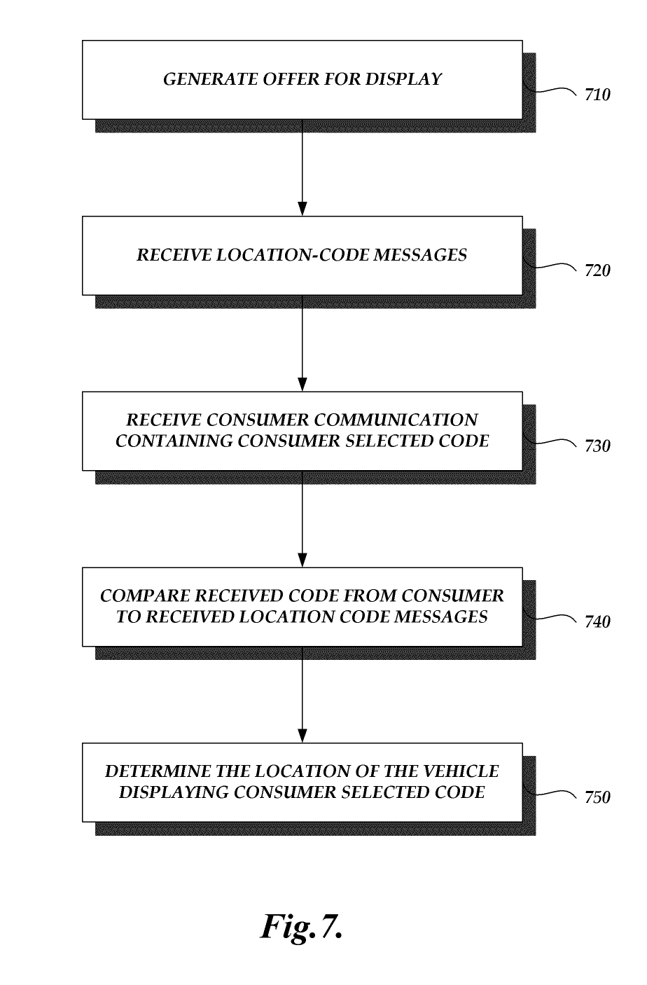

FIG. 7 is a flowchart illustrating a process flow for distributing offers using vehicle displays in one embodiment of a deal manager computer system. At box 710, the deal manager generates an offer for display. The offer may be for a deal at a venue such as concert, comedy club or casino, for example. The offer may include, in some embodiments, a plurality of deal codes corresponding to the offer. For example, the offer may be for discount tickets to a concert, and the deal codes may be “ABC”, “123” and “456.” In some embodiments, the deal manager 100 may communicate the offer, with the plurality of deal codes, to a computing system that is associated with a vehicle. For example, the deal manager 100 may communicate the offer and the plurality of deal codes to a display computer system that is attached to the exterior of a for-hire vehicle (for example, the display shown in FIGS. 1B, 2A, and 5A). In some embodiments, the display computer system displays one of the plurality of deal codes along with details of the offer so that consumers interested in finding out more details about the offer may send the deal code to the deal manager.

Next, in box 720, the deal manager may receive one or more location-code messages. The location-code messages may be received from a for-hire vehicle and each message may contain the location of the for-hire vehicle at the time the message is sent and the deal code displayed by the for-hire vehicle at the time the message is sent. In some embodiments, the deal code indicated in the location-code messages is one of the plurality of deal code messages sent to the display computer system at box 710. In some embodiments, the deal manager 100 may receive location-code messages periodically. For example, the deal manager 100 may receive the location-code messages every second, minute, 5 minutes, or any other time period one skilled in the art may determine is appropriate in operation.

At box 730, the deal manager may receive a consumer communication containing a consumer selected code. The communication from the consumer may originate from an application executing on a computing device that is controlled by the consumer. The consumer selected code may be a deal code the consumer saw on a vehicle displaying a deal code, and may be one of the plurality of deal codes generated in box 710. Once received, the deal manager may compare the deal code to the received location code messages at box 740. When the deal manager finds a location-code message received from a vehicle that matches the consumer selected code received from the consumer, the deal manager 100 may then, at box 750, advantageously determine the location of the for-hire vehicle using the location from the location-code message with the matching deal code.

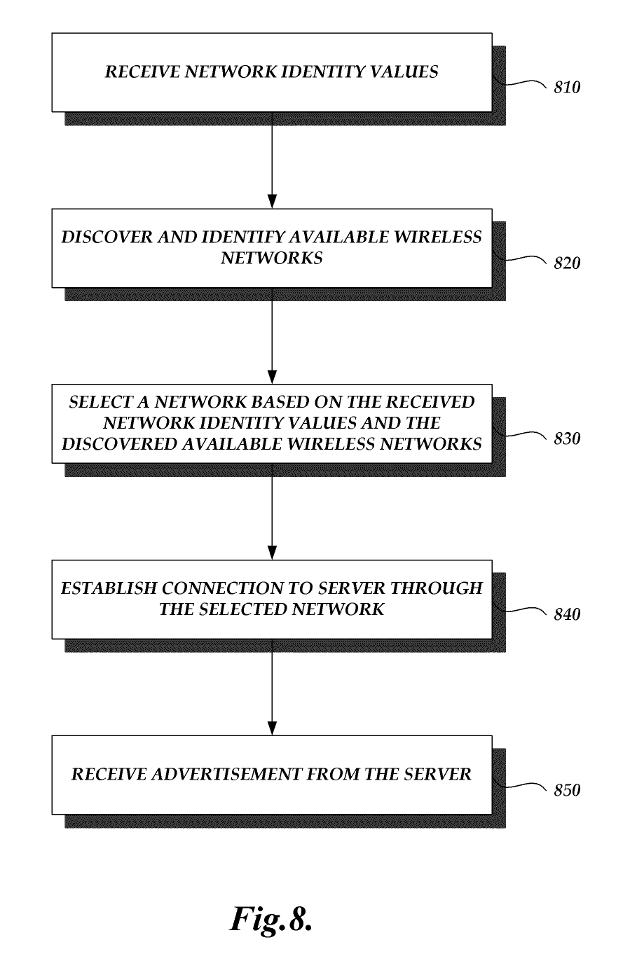

FIG. 8 is a flowchart illustrating a process flow for displaying an advertisement in one embodiment of a deal presenter computer system. At box 810, the deal presenter computer system 110 may receive a plurality of network identity values. In some embodiments, the network identity values represent the names of one or more wireless networks available through mobile hotspots of vehicles. In some embodiments, the deal presenter 110 searches for available wireless networks at box 820 and may do so by checking if any of the network identity values received in box 810 are available. For example, when the deal presenter receives the network identity values “A”, “B” and “C” at box 810, it may periodically check for the availability for networks named “A”, “B” and “C.” Next, at box 830, if the deal presenter discovers an available network, it may establish a connection on that network. For example, if the deal presenter 110 discovers that “A” is not available, but that “B” is available, it may establish a connection on network “B.”

At box 840, the deal presenter may establish a connection to a server through the selected network. The server may be, in some embodiments, a deal manager computer system. In some embodiments, once the deal presenter established a connection with the server, or deal manager 100, an advertisement may be communicated to the deal presenter at box 850. In other embodiments, the deal presenter may first transmit a deal code to the deal manager. The deal code may be a code entered by a consumer. For example, the deal presenter may establish a connection over the “B” network. The “B” network may be the identifier for the network that is associated with a FHV displaying the deal code “123.” The consumer may enter “123” into an application that is executing on the deal presenter 110. Once “123” has been entered by the consumer, the deal presenter may then communicate the deal code “123” to the deal manager 100. In response, the deal manager 100 may then communicate, at box 850, an advertisement to the deal presenter which may display it for the consumer.

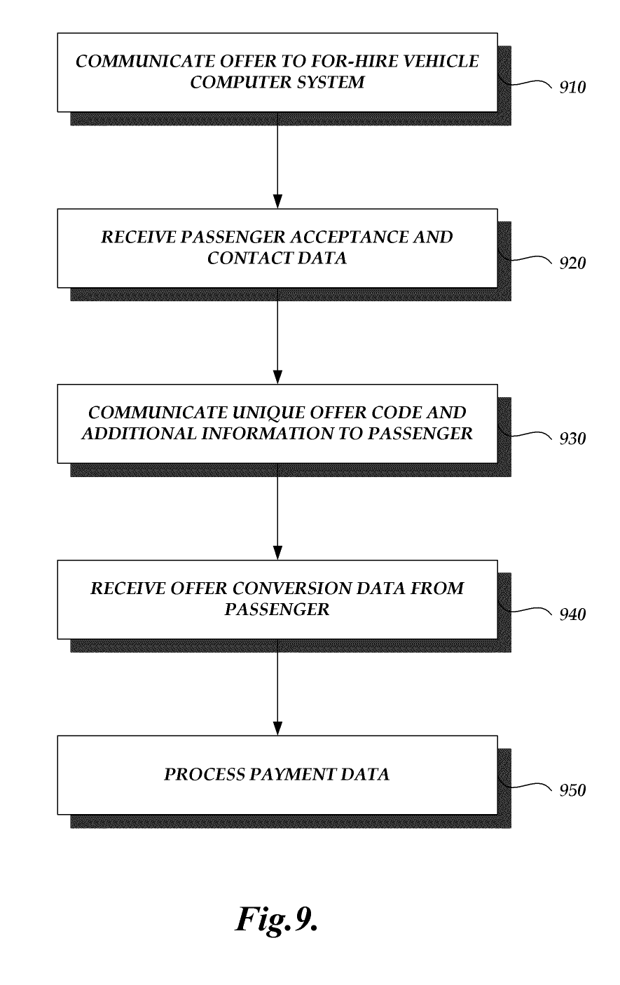

FIG. 9 is a flowchart illustrating the process flow for communicating an offer to a passenger of a for-hire vehicle in one embodiment of a deal manager computer system. At box 910, the deal manager 100 may communicate an offer to a for-hire vehicle computer system. The for-hire vehicle computer system may include, in some embodiments, a display for displaying the offer to passengers in the for-hire vehicle. The for-hire vehicle computer system may also include an input device such as a touch screen or keyboard for accepting user input. The passenger may wish to accept the offer displayed by the for-hire vehicle computer system. When a passenger accepts the offer, the for-hire vehicle computer system may collect contact data from the passenger, such as a mobile phone number or email address. At box 920, the deal manager computer system receives the acceptance data and the contact data from the for-hire vehicle computer system. Using the received contact data, the deal manager 100 at box 930 communicates a unique offer code to a passenger corresponding to the offer displayed with respect to box 910. For example, if the contact data includes a mobile phone number, the deal manager 100 may communicate the unique offer code to the consumer via text message. The deal manager 100 may also at box 930, communicate additional information to the consumer regarding a deal. The additional information may include further details about the deal such as pricing information, a deal description, or other information that may be useful to the consumer.

Once the consumer receives the unique offer code, it may enter the code in an application executing on a computing device controlled by the consumer such as a mobile computing device. In some embodiments, entry of the unique offer code may trigger acceptance of the offer communicated in box 930. For example, if the offer was for discount tickets to a play, the consumer may purchase the tickets by entering the unique code. In some embodiments, the consumer may also enter payment information such as credit card data, debit card data, rewards card data, or some other payment information. Then, at box 940, the deal manager computer system may receive the acceptance data and the payment data. Once received, the deal manager 100 may process the payment information at box 950.

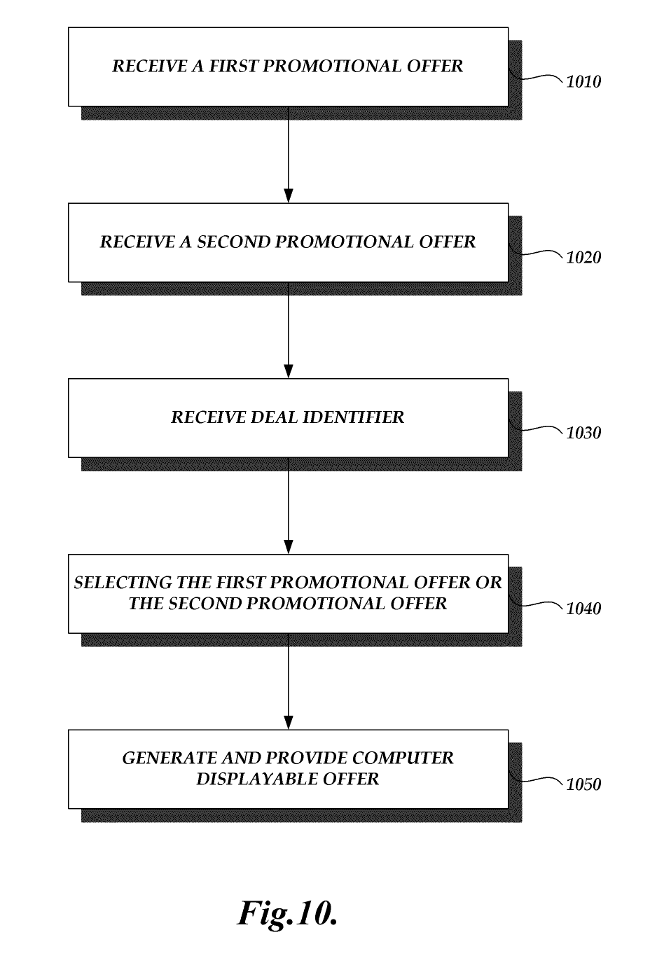

FIG. 10 is a flowchart illustrating a process flow for providing a promotional offer to a consumer in one embodiment of a deal manager computer system. At box 1010, the deal manager 100 may receive a first promotional offer from a first venue. For example, it may receive a first promotional offer from a casino. Then, at box 1020, the deal manger 100 may receive a second promotional offer from a second venue. For example, the deal manager 100 may receive a second promotional offer from a restaurant. Next, at box 1030, the deal manager may receive a deal identifier. The deal identifier may be, in some embodiments, a deal code that was displayed on a vehicle. The deal identifier may be received from a consumer computing device. In some embodiments, the consumer computing device may execute a custom application that allows a consumer to enter deal identifiers which are then communicated to the deal manager. In other embodiments, the deal identifier may be received from a consumer computing device through a website that is maintained by the deal manager. Then at box 1040, the deal manger 100 determines whether to provide to the requester the first promotional offer or the second promotional offer. The deal manger may select the first or second promotional offer based on the location of the consumer at the time the consumer sent the deal identifier. In other embodiments, the deal manager 100 may select the first or second promotional offer based on the received deal identifier. In yet other embodiments, the deal manager 100 may select the first or the second promotional offer based on location data that is transmitted to the deal manager, which in some embodiments may be received with the deal identifier. Once the deal manager selects the first or the second promotional offer, it may then generate a computer displayable offer. In some embodiments, the computer displayable offer is communicated to the computing device from which the deal identifier was received.

All of the methods and tasks described herein may be performed and fully automated by a computer system. The computer system may in some cases include multiple distinct computers or computing devices (for example, physical servers, workstations, storage arrays, etc.) that communicate and interoperate over a network to perform the described functions. Each such computing devices typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (for example, ASICs or FPGAs) of the computer system. Where the computer system includes multiple computing devices, these devices may, but need not, be co-located. The results of the disclosed methods and tasks may be persistently stored by transforming physical storage devices such as solid state memory chips and/or magnetic disks, into a different state.

In addition, the methods described herein may be executed on suitable computing devices in response to execution of software instructions or other executable code read from a non-transitory tangible computer readable medium, computer readable storage or computer storage device. A computer readable medium is a data storage device that can store data that is readable by a computer system. The term “non-transitory,” as used in conjunction with tangible computer readable medium, computer readable storage, computer storage device, and the like, excludes only propagating transitory signals per se from the scope of these terms. Thus, “non-transitory” does not relinquish rights to all standard computer-readable media that are not solely propagating transitory signals per se. Examples of computer readable mediums include read-only memory, random-access memory, other volatile or non-volatile memory devices, CD-ROMs, magnetic tape, flash drives, and optical data storage devices.

The various computing systems described herein may be IBM, Macintosh or Linux/Unix compatible. The various computing systems may, in some embodiments, include one or more central processing units (“CPU”), which may include one or more conventional or proprietary microprocessors. The various computing systems may further include memory, such as random access memory (“RAM”) for temporary storage of information and read only memory (“ROM”) for permanent storage of information, and a data store, such as a hard drive, diskette, or optical media storage device. Embodiments of the data store may store data in databases, flat files, spreadsheets, or any other data structure known in the art. Typically, the modules of the various computing systems are in communication with one another via a standards based bus system. In different embodiments, the standards based bus system could be Peripheral Component Interconnect (PCI), Microchannel, SCSI, Industrial Standard Architecture (ISA) and Extended ISA (EISA) architectures, for example. In another embodiment, The various computing systems leverage computing and storage services available over the Internet (cloud computing).

The various computing systems may be generally controlled and coordinated by operating system software, such as the Windows 95, 98, NT, 2000, XP, Vista, Linux, SunOS, Solaris, PalmOS, Blackberry OS, or other compatible operating systems. In Macintosh systems, the operating system may be any available operating system, such as MAC OS X. In another embodiment, the various computing systems may be controlled by a proprietary operating system, that is one that had been custom made for the purposes of embodying the systems and methods described herein. Conventional operating systems control and schedule computer processes for execution, perform memory management, provide file system, networking, and I/O services, and may provide a user interface, such as a graphical user interface (“GUI”) for display, among other things.

The various computing systems may also include one or more commonly available I/O devices and interfaces, such as for example, a printer, buttons, a keyboard, a LED display, a monitor, a touchpad, a USB port, a RS 232 port and the like. In one embodiment, the I/O devices and interfaces include one or more display devices, such as a monitor, that allows the visual presentation of data to a user. The I/O devices and interfaces may provide a communication interface to various external devices. The various computing systems may be in communication with a network, and the network may be any combination of one or more LANs, WANs, or the Internet, for example. The communications interface may also include, for example, ports for sending and receiving data such as a USB port or an RS 232 port.

The various computing systems may also include several application modules that may be executed by the CPU. The software code of the modules may be stored on a tangible computer-readable medium such as for example, RAM or ROM. In general, the word module, as used herein, refers to logic embodied in hardware or firmware, or to a collection of software instructions stored on a non-transitory and/or tangible computer-readable storage, possibly having entry and exit points, written in a programming language, such as, for example, C, C++, C#, or Java. A software module may be compiled and linked into an executable program, installed in a dynamic link library, or may be written in an interpreted programming language such as, for example, BASIC, Perl, or Python. Software modules may be callable from other modules or from themselves, and/or may be invoked in response to detected events or interrupts. Software modules may be stored in any type of computer-readable storage, such as a memory device (for example, random access, flash memory, and the like), an optical medium (for example, a CD, DVD, BluRay, and the like), firmware (for example, an EPROM), or any other storage medium. The software modules may be configured for execution by one or more CPUs in order to cause computing systems described herein.

It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of advertising using vehicle displayed advertisements, the method comprising:
associating, by a first computer system, a unique identifier with a vehicle wherein the vehicle is configured to display an advertisement;
receiving, by the first computer system, in response to the vehicle displayed advertisement, a request from a second computer system for additional information, the request comprising the unique identifier;
determining, by the first computer system, the additional information to be provided based at least in part on the unique identifier;
providing, by the first computer system, the additional information to the second computer system; and,
determining, by the first computer system, the location of the vehicle at the time the request for the additional information was made from the second computer system.

2. The method of claim 1, wherein the location of the vehicle, at the time of the request for the additional information, is determined at least in part from location data received from the vehicle.

3. The method of claim 1, wherein the location of the vehicle, at the time of the request for the additional information, is determined at least in part from location data received from the second computer system, the location data providing an indication of the location of the second computer system at the time the request for the additional information was made.

4. The method of claim 1, wherein the advertisement comprises the unique identifier.

5. The method of claim 1, wherein the second computer system executes an application, the application comprising a user interface for entering the unique identifier.

6. The method of claim 1, wherein the unique identifier is displayed as an image.

7. The method of claim 1, wherein the second computer system executes an application, the application configured to scan the unique identifier.

8. The method of claim 1, wherein the second computer system is a handheld computing device.

9. The method of claim 1, wherein the unique identifier is a QR Code.

10. The method of claim 1, wherein the unique identifier is an alphanumeric code.

11. The method of claim 1, wherein the unique identifier is a medallion associated with the vehicle.

12. The method of claim 1, wherein the unique identifier is a license plate associated with the vehicle.

13. A system for advertising using vehicle displayed advertisements, the system comprising:
a processor;
a storage medium storing processor readable instructions that when executed cause a processor to:
associate a unique identifier with a vehicle wherein the vehicle is configured to display an advertisement;
receive, in response to the vehicle displayed advertisement, a request from a second computer system for additional information, the request comprising the unique identifier;
determine the additional information to be provided based at least in part on the unique identifier;
provide the additional information to the second computer system; and,
determine the location of the vehicle at the time the request for the additional information was made from the second computer system.

14. The system of claim 13, wherein the location of the vehicle, at the time of the request for the additional information, is determined at least in part from location data received from the vehicle.

15. The system of claim 13, wherein the location of the vehicle, at the time of the request for the additional information, is determined at least in part from location data received from the second computer system, the location data providing an indication of the location of the second computer system at the time the request for the additional information was made.

16. The system of claim 13, wherein the advertisement comprises the unique identifier.

17. The system of claim 13, wherein the second computer system executes an application, the application comprising a user interface for entering the unique identifier.

18. The system of claim 13, wherein the unique identifier is displayed as an image.

19. The system of claim 13, wherein the second computer system executes an application, the application configured to scan the unique identifier.

20. The system of claim 13, wherein the second computer system is a handheld computing device.

21. The system of claim 13, wherein the unique identifier is a QR Code.

22. The system of claim 13, wherein the unique identifier is an alphanumeric code.

23. The system of claim 13, wherein the unique identifier is a medallion associated with the vehicle.

24. The system of claim 13, wherein the unique identifier is a license plate associated with the vehicle.

25. A method of offering discount vouchers comprising:
generating, by a computer system, an advertisement associated with a unique identifier, the unique identifier further associated with a vehicle;
communicating, by the computer system, to a vehicle computer system associated with the vehicle an instruction to display the advertisement;
receiving, by the computer system, a consumer communication from a consumer application configured to execute on a consumer computing system, the consumer communication comprising the unique identifier associated with the vehicle,
generating, by the computer system, an offer for goods or services based at least in part on the unique identifier of the consumer communication; and
communicating, by the computer system, the offer for goods or services to the consumer computing system.

26. The method of claim 25, further comprising receiving, by the computer system, an acceptance of the offer for goods or services from the consumer computer system.

27. The method of claim 26 wherein the acceptance of the offer comprises consumer payment information.

28. The method of claim 27 further comprising, processing, by the computer system, the consumer payment information.

29. The method of claim 25 wherein the consumer communication further comprises personal data about the consumer.

30. The method of claim 29 further comprising sending, by the computer system, one or more additional advertising offers to the consumer application configured to execute on the consumer computing system based at least in part on the personal data about the consumer.

31. The method of claim 25, wherein the consumer application comprises a user interface for entering the unique code.

32. The method of claim 25, wherein the unique code is obtained from a scanned image.

33. A system for offering discount vouchers comprising:
a processor;
a storage medium storing processor readable instructions that when executed cause a processor to:
generate an advertisement associated with a unique identifier, the unique identifier further associated with a vehicle;
communicate to a vehicle computer system associated with the vehicle an instruction to display the advertisement;
receive a consumer communication from a consumer application configured to execute on a consumer computing system, the consumer communication comprising the unique identifier associated with the vehicle,
generate an offer for goods or services based at least in part on the unique identifier of the consumer communication; and
communicate the offer for goods or services to the consumer computing system

34. The system of claim 33, wherein the processor readable instructions when executed further cause the processor to receive an acceptance of the offer for goods or services from the consumer computer system.

35. The system of claim 34 wherein the acceptance of the offer comprises consumer payment information.

36. The system of claim 35 wherein the processor readable instructions when executed further cause the processor to process the consumer payment information.

37. The system of claim 33, wherein the consumer communication further comprises personal data about the consumer.

38. The system of claim 37 wherein the processor readable instructions when executed further cause the processor to send one or more additional advertising offers to the consumer application configured to execute on the consumer computing system based at least in part on the personal data about the consumer.

39. The system of claim 33, wherein the consumer application comprises a user interface for entering the unique code.

40. The system of claim 33, wherein the unique code is obtained from a scanned image.

41. A method of distributing offers using vehicle displays, the method comprising:
generating through a computer system, an offer configured for display by the vehicle;
receiving, by the computer system, one or more location-code messages from the vehicle, the one or more location-code messages comprising:
location information describing the location of the vehicle when the vehicle sent the location-code message, and
a currently displayed code that is among the one or more codes associated with the vehicle;
receiving, by the computer system, a consumer communication comprising a consumer selected code that is among the one or more codes associated with the vehicle;
comparing, by the computer system, the consumer selected code of the consumer communication to the currently displayed code that is part of the one or more location-code messages to determine a matched location-code message; and,
determining the location of the vehicle using the location information of the matched location-code message.

42. The method of claim 41, further comprising:
communicating, by the computer system, the one or more codes associated with the vehicle to a display computer system associated with the vehicle.

43. The method of claim 42 wherein the display computer system associated with the vehicle is configured to display one of the one or more codes associated with the vehicle for a period of time.

44. A system comprising:
a processor;
storage medium storing processor readable instructions that when executed cause the processor to:
receive a plurality of network identity values, the plurality network identity values identifying one or more wireless networks associated with one or more vehicles;
identify one or more available wireless networks broadcasting from one or more vehicles,
determine a selected network by comparing the one or more available wireless networks to the received network identity values;
establish a connection to a server through the selected network whereby the server is provided with sufficient information to identify the vehicle and to select an advertisement based in part on that identification; and,
receive an advertisement from the server.

45. The system of claim 44, wherein the processor readable instructions when executed further cause the processor to receive one or more advertising codes via the selected network.

46. The system of claim 45, wherein the processor readable instructions when executed further cause the processor to display the received one or more advertising codes in a user interface for selection.

47. The system of claim 44, wherein the processor readable instructions when executed further cause the processor to receive an offer for goods or services in response to communicating the advertising code and the network identity value.

48. The system of claim 47, wherein the processor readable instructions when executed further cause the processor to receive an acceptance of the offer from the user.

49. The system of claim 48, wherein the processor readable instructions when executed further cause the processor to communicate the acceptance to the server.

50. The system of claim 49, wherein the processor readable instructions when executed further cause the processor to communicate payment information of the user to the server.

51. A method of providing feedback regarding vehicle advertising impressions, the method comprising:
periodically receiving, by a computer system, one or more vehicle communications, the vehicle communications comprising a vehicle location;
receiving, by the computer system, a consumer communication, the consumer communication comprising a consumer location, and consumer input data, wherein the consumer input data represents unique information displayed by a vehicle; and
determining, by the computer system, a vehicle location by comparing the consumer communication to the one or more for-hire vehicle communications.

52. A system for providing feedback regarding vehicle advertising impressions, the system comprising:
a processor;
a storage medium storing processor readable instructions that when executed cause the processor to:
periodically receive one or more vehicle communications, the vehicle communications comprising a vehicle location;
receive a consumer communication, the consumer communication comprising a consumer location, and consumer input data, wherein the consumer input data represents unique information displayed by a vehicle; and
determine a vehicle location by comparing the consumer communication to the one or more for-hire vehicle communications.

53. A method comprising:
providing, by an advertising computer system, an offer configured for display on a for-hire vehicle computer system;
communicating, by the advertising computer system, the offer to the for-hire vehicle computer system;
receiving, by the advertising computer system, passenger acceptance data comprising an indication that a passenger of a for-hire vehicle has accepted an offer;
receiving, by the advertising computer system, passenger contact information data;
communicating, by the advertising computer system, a unique offer code to the passenger using the received passenger contact information data; and
receiving, by the advertising computer system, offer conversion data from a passenger computer system, the offer conversion data comprising:
the unique offer code, and
passenger payment data;
wherein the passenger inputted the unique offer code into an application executing on the passenger computer system configured to communicate with the advertising computer system, and
wherein the passenger payment data was generated by the mobile application based at least in part on data entered by the passenger and stored on the passenger computer system.

54. A method of providing a promotional offer to a consumer, the method comprising:
receiving, by a first computer system, a first promotional offer relating to a first venue at a first location;
receiving, by the first computer system, a second promotional offer relating to a second venue at a second location;
receiving, by the first computer system, a deal identifier representing the identity of a vehicle;
selecting, by the first computer system, either the first promotional offer or the second promotional offer based at least in part on the deal identifier; and,
generating, by the first computer system, a computer displayable offer based on the selection of the first promotional offer or the second promotional offer.

55. The method of claim 54, wherein the first computer system receives the deal identifier from a second computer system and the method further comprises communicating, by the first computer system, the computer displayable offer to the second computer system.

56. The method of claim 55, further comprising receiving, by the first computer system, location data from the second computer system.

57. The method of claim 56, wherein the selecting of either the first promotional offer or the second promotional offer is further based at least in part on the received location data of the second computer system.

58. The method of claim 54, further comprising, receiving, by the first computer system, personal data about a consumer.

59. The method of claim 58, wherein the selecting of either the first promotional offer or the second promotional offer is further based at least in part on the received personal data about the consumer.

60. The method of claim 54, further comprising receiving, by the first computer system location data describing the location of the vehicle identified by the deal identifier.

61. The method of claim 60 wherein the selecting of either the first promotional offer or the second promotional offer is further based at least in part on the received location data describing the location of the vehicle identified by the deal identifier.
